(19) United States
(12) Patent Application Publication
(10) Pub. No.: US 2026/0299756 A1
(43) Pub. Date: Oct. 1, 2026

(54) INFORMATION PROCESSING APPARATUS, DISPLAY CONTROL METHOD, AND STORAGE MEDIUM

(71) Applicant: CANON KABUSHIKI KAISHA, Tokyo (JP)

(72) Inventor: YUTO OSADA, Kanagawa (JP)

(21) Appl. No.: 19/573,153

(22) Filed: Mar. 20, 2026

(30) Foreign Application Priority Data
Mar. 27, 2025 (JP) 2025-053970

(51) Int. Cl. G06F 3/0482; G06F 3/04842; G06F 16/535; G06T 11/60

(52) U.S. Cl. CPC G06F 3/0482; G06F 3/04842; G06F 16/535; G06T 11/60

(57) ABSTRACT

An information processing apparatus includes a display control unit configured to array and display a plurality of candidate images that are candidates for an image to be arranged in layout data on content, and a changing unit configured to change an order of arraying the candidate images such that a first candidate image is displayed at a farther backward position than a second candidate image, the first candidate image being one of the candidate images that includes a first subject, the second candidate image being one of the candidate images that does not include the first subject, the first subject being a subject of a same type as a subject recognized from a specific image.

### BACKGROUND

### Field of the Technology

The present disclosure relates to an information processing apparatus assisting in producing content such as a poster, and relates to a display control method, and a storage medium.

### Description of the Related Art

Application programs (hereinafter, referred to as apps) for creating and editing layout data on a production such as a poster or a photo album (hereinafter, referred to as content) have been provided. As a technique pertaining to the creation of layout data, Japanese Patent Laid-Open No. 2023-022712 (Patent Literature 1) presents a technique in which an app automatically selects a template on a basis of the number of characters of a text input by a user and the number of images. The user can complete the layout data by replacing a text or an image that is laid out on the template in advance.

However, the user may not be able to prepare an image to be arranged in the layout data. In this case, although the user can utilize free stock materials, a stock photo service, or the like to obtain an image, selecting an appropriate image from a large collection of images takes both time and effort. For this reason, there is a demand for improving usability in preparing images for producing content.

### SUMMARY

An information processing apparatus according to some embodiments of the present disclosure includes a display control unit configured to array and display a plurality of candidate images that are candidates for an image to be arranged in layout data on content, and a changing unit configured to change an order of arraying the candidate images such that a first candidate image is displayed at a farther backward position than a second candidate image, the first candidate image being one of the candidate images that includes a first subject, the second candidate image being one of the candidate images that does not include the first subject, the first subject being a subject of a same type as a subject recognized from a specific image.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the configuration of an information processing system.

FIG. 2 is a diagram illustrating the hardware configuration of a server.

FIG. 3 is a diagram illustrating the hardware configuration of a client terminal.

FIG. 4 is a diagram illustrating the hardware configuration of an image output device.

FIG. 5 is a diagram illustrating a software configuration of the information processing system.

FIG. 6 is a block diagram illustrating the functional configuration of an editing app.

FIG. 7 is a diagram illustrating the data configuration of an information file included in a template.

FIG. 8 is a diagram illustrating a basic settings screen of the editing app.

FIG. 9 is a flowchart illustrating a layout data generating process.

FIG. 10 is a diagram illustrating an example of inputs into the basic settings screen made by a user.

FIG. 11 is a diagram showing the relationship of FIGS. 11A and 11B.

FIG. 11A is a flowchart illustrating an automatic image adding process.

FIG. 11B is a flowchart illustrating the process of processing following FIG. 11A.

FIG. 12 is a diagram illustrating an example of candidate images obtained in S1103.

FIG. 13 is a diagram illustrating an example of an image recognition result in S1104.

FIG. 14 is a diagram illustrating an example of an image selection screen in a first embodiment.

FIG. 15 is a diagram illustrating a display example of an image setting screen in a case where undesignated subjects are prioritized.

FIG. 16 is a diagram illustrating an example of an image selection screen in a second embodiment.

FIG. 17 is a flowchart illustrating an automatic image adding process in the second embodiment.

FIG. 18 is a diagram illustrating an example of the image selection screen after a sort in the second embodiment.

FIG. 19 is a diagram illustrating an example of an image selection screen in a third embodiment.

FIG. 20 is a diagram illustrating the functional configuration of an editing app in the third embodiment.

FIG. 21 is a flowchart illustrating an automatic image adding process in the third embodiment.

FIG. 22 is a diagram illustrating an example of the image selection screen after a sort in the third embodiment.

### DESCRIPTION OF THE EMBODIMENTS

Hereinafter, various exemplary embodiments, features, and aspects of the present disclosure will be described in detail with reference to the accompanying drawings. Note that the embodiments described below are not intended to limit the scope of the claims, and all of the combinations of features described in the embodiments are not necessarily indispensable to a solution according to the present disclosure.

### First Embodiment

First, an information processing system according to an embodiment of the present disclosure will be described. As an example of the information processing system, a print system implementing the function of generating/editing layout data and the printout function of rendering the layout data into an image and printing out the image will be described. The layout data herein refers to data used for editing content (a production) such as a poster. Layout data rendered into an image will be referred to as a content image. In the following embodiment, a poster will be described as an example of content to be processed by a print system. A poster image, which is a content image, is utilized in a printed form. Besides the utilization, the poster image may be utilized as electronic content for a website, Social Networking Service (SNS), virtual space, or the like. The content is not limited to a poster. The content encompasses a brochure, a menu, a postcard, a leaflet (flyer), a flag, a business card, a shop card, a letter of invitation, a membership card, and the like.

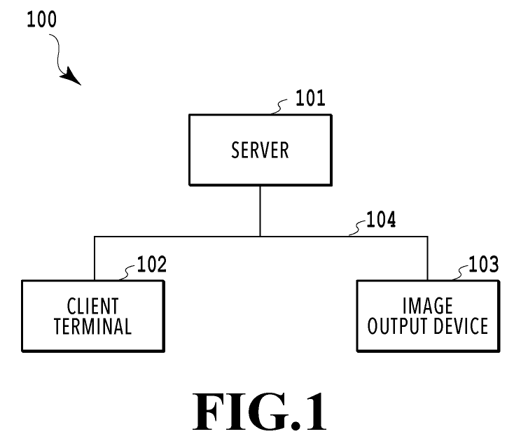

FIG. 1 is a diagram illustrating a system configuration of a print system 100 as an example of the information processing system. The print system 100 includes a server 101 providing the service of generating/editing the layout data and a client terminal 102 performing a process of generating/editing the layout data in coordination with the server 101. In the present embodiment, the process of generating layout data on a poster will be described as an example. The print system 100 includes an image output device 103 that outputs a content image. Although the image output device 103 is assumed to be a printer that makes a printout of the content image in the present embodiment, the image output device 103 may be a multifunction peripheral (MFP) or the like.

The server 101, the client terminal 102, and the image output device 103 are in communication connection with one another, via a network 104. The network 104 encompasses a communication network such as a local area network (LAN) or the Internet, a short range communication such as Bluetooth (R), and other types of communication networks. The network 104 may be either wired or wireless. FIG. 1 illustrates the system configuration in which one server 101, one client terminal 102, and one image output device 103 are connected together. The system configuration is not limited to this. Each of the numbers of connected servers 101, client terminals 102, and image output devices 103 may be more than one. For example, the server 101 may be a server system that is constituted by a plurality of server computers. That is, a process executed by the server 101 may be executed by only one server computer or may be executed by a plurality of server computers working in cooperation with one another.

With the print system 100, a user uses the client terminal 102 as a user interface for the execution of the process of generating/editing the layout data in the server 101. The client terminal 102 is equipped with a web browser and displays display data on a user interface (UI) screen transmitted from the server 101 on a display device of the client terminal 102. The client terminal 102 receives various instructions on the layout data or an input of data from the user via a UI screen and transmits the received instructions and data to the server 101. On a basis of the received instructions and data, the server 101 executes a process and transmits data on the result of the process to the client terminal 102. The client terminal 102 reflects the data on the result of the process transmitted from the server 101 on the layout data displayed on the UI screen, displaying the data in a visible manner. The details of the process of generating/editing the layout data, and the UI screen will be described later.

In a case of making a printout of the layout data generated through the process of generating/editing the layout data, the user operates the client terminal 102 to obtain image data on an image into which the layout data is rendered. In addition, a print job including the image data given print setting data is generated, and the print job is transmitted to the image output device 103. The process of rendering the layout data into an image may be performed by the server 101 or may be performed by the client terminal 102. The image output device 103 executes print processing based on the print job. The generation of the print job can be executed using a print application program (hereinafter, referred to as a print app) installed on the client terminal 102 or using a print function of an OS. In the present embodiment, the print app and a printer driver are assumed to be installed on the client terminal 102. The print app and the printer driver will be described later.

The server 101 or the client terminal 102 includes an application program that implements the function of generating/editing the layout data (hereinafter, referred to as an editing app). The editing app may be in any form. The editing app may be a web app that operates on the browser in the client terminal 102 in coordination with the server 101 via the web or may be a native app that is installed on the client terminal 102. The client terminal 102 requests a part or all of the process from the server 101 and obtains the result of the part or all of the process from the server 101. The editing app will be described later.

The image output device 103 executes the printing of a print image of the layout data (the poster image) that is generated with the editing app on a basis of the print setting in the print job received from the client terminal 102. The image output device 103 retains, as device information, information on supported inks, configuration information about a paper sheet, and status information indicating an idle state, a printing error state, or the like. Furthermore, in a case where the image output device 103 fails to execute printing normally due to a problem in the image output device 103 or an error in the print setting, such as insufficient amount of remaining paper or ink depletion, the image output device 103 displays a warning message on a main panel of the image output device 103. Thus, the reason for failing the normal printing is notified to the user.

### Hardware Configuration

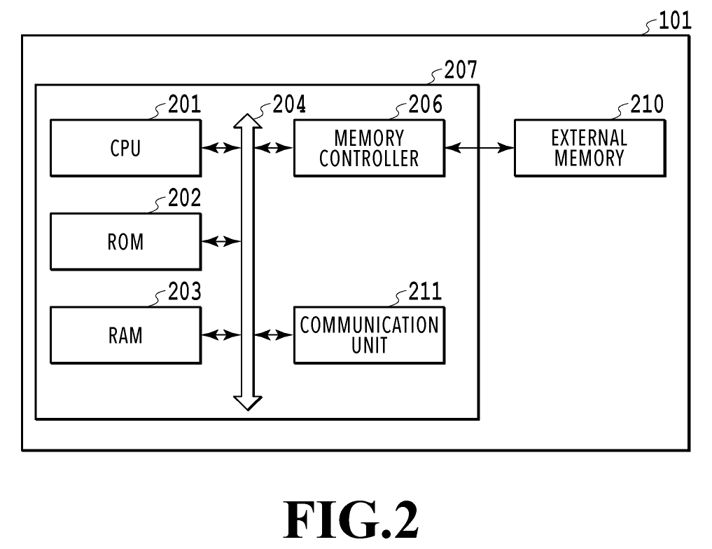

FIG. 2 is a diagram illustrating an example of a hardware configuration of an information processing apparatus functioning as the server 101 of the print system 100. The server 101 is a computer including a main board 207 and an external memory 210. On the main board 207, a CPU 201, a ROM 202, a RAM 203, a communication unit 211, a memory controller 206, and the like are arranged. These units are connected together via a bus 204. The CPU 201 reads various programs such as a control program, a system program, and an application program read from the ROM 202, the external memory 210, or the like into the RAM 203. The CPU 201 executes the programs read into the RAM 203 to execute various types of data processing. The CPU 201 may be a dedicated circuit such as an ASIC. The CPU 201 or the dedicated circuit is an example of a hardware circuit and a hardware processor. The ROM 202 is a non-volatile memory in which an operating system, a built-in program, and data are stored. The RAM 203 is a volatile memory providing a temporary memory area.

The memory controller 206 is connected to the external memory 210. The memory controller 206 controls reading data from and writing data to the external memory 210 in accordance with a control signal from the CPU 201. The external memory 210 is a mass storage device such as a flash memory, an HDD, or an SSD. The external memory 210 may be an external storage that is in communication connection via the communication unit 211.

In the external memory 210 or the ROM 202 of the server 101, various application programs such as a server program of the editing app, which will be described later, a print image generating program, and a back-end app for the editing app are stored. In the external memory 210 or the ROM 202 of the server 101, a layout data DB 514 and data for use in various types of processing to be executed by the server 101 are stored.

The communication unit 211 includes a communication control circuit and a communication port. The communication unit 211 may include a unit for implementing the Bluetooth (R) Low Energy (BLE) communication method. The CPU 201 is connected to the network 104 via the communication unit 211 and communicates with the client terminal 102 and the image output device 103, and another computer or network device.

Note that the configuration of the server 101 is not limited to the configuration illustrated in FIG. 2 and can be modified as appropriate. For example, the configuration may include an input device and a displaying device such as a display device, a keyboard, a mouse, buttons, and a touch panel.

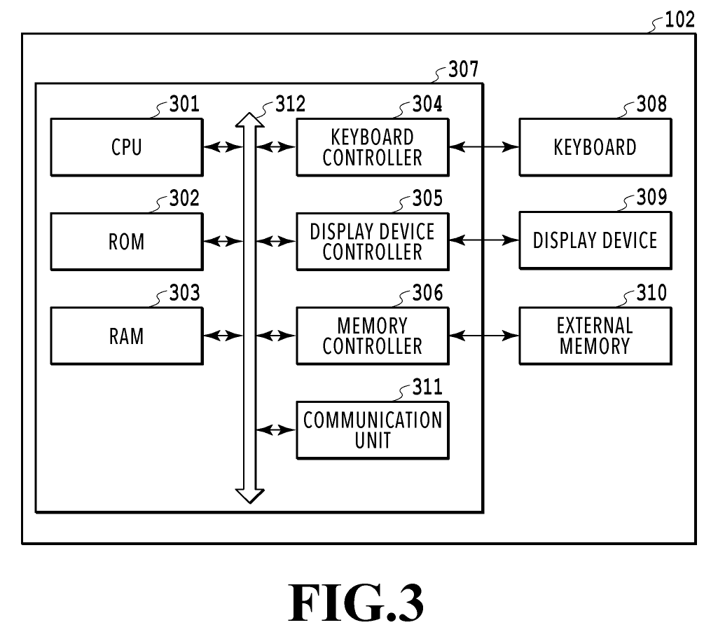

FIG. 3 is a diagram illustrating an example of a hardware configuration of an information processing apparatus functioning as the client terminal 102 of the print system 100. The client terminal 102 is configured with a personal computer (PC), a smartphone, a tablet computer, or the like. FIG. 3 illustrates a configuration of a PC as an example. The client terminal 102 includes a main board 307, a keyboard 308, a display device 309, and an external memory 310. On the main board 307, a CPU 301, a ROM 302, a RAM 303, a keyboard controller 304, a display device controller 305, a memory controller 306, a communication unit 311, and the like are arranged. These units are connected together via a bus 312. The CPU 301, the ROM 302, the RAM 303, the memory controller 306, the external memory 310, and the communication unit 311 function similar to those of the server 101 mentioned above.

In the external memory 310 of the client terminal 102, various application programs such as a client program of the editing app, a print application program, a printer driver, and a web browser, and data for processing according to the programs are stored.

The display device controller 305 is a display control circuit for displaying display data output from the CPU 301 on the display device 309. The display device 309 is a liquid crystal display, an organic EL display device, or the like. The keyboard controller 304 is connected to the keyboard 308 and inputs, into the CPU 301, information and an operation signal that are input by the user with the keyboard 308. Note that, in addition to the keyboard 308, the client terminal 102 may include a mouse, buttons, a touch panel, or the like, as input equipment.

Note that the configuration of the client terminal 102 is not limited to the configuration illustrated in FIG. 3 and can be modified as appropriate. For example, a computer having a simple configuration that does not include a part of the configuration illustrated in the figure may be utilized. In this case, the computer can be made to function as the information processing apparatus by connecting to another computer and performing remote operations by means of the function of a remote desktop, a remote shell or the like. Alternatively, for example, in a case where a smartphone is utilized as the client terminal 102, the client terminal 102 may have a configuration including a microphone and a loudspeaker for a telephony function, a camera for an image capturing function, and the like, in addition to the illustrated constituent elements.

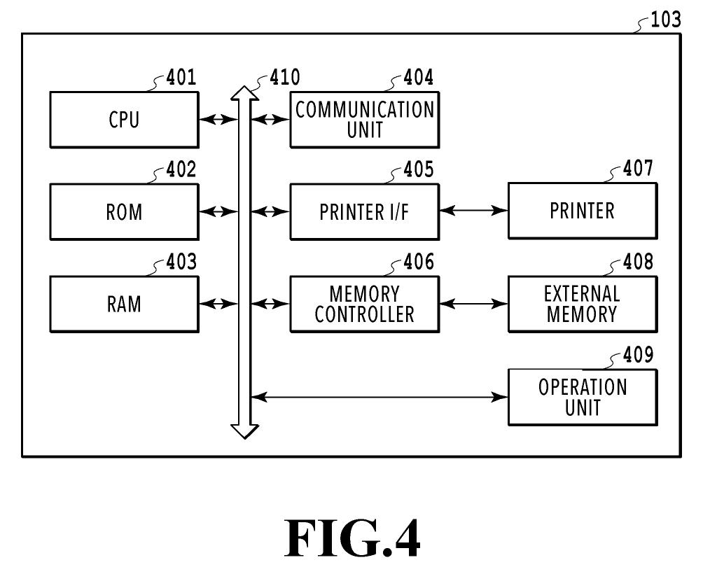

FIG. 4 is a diagram illustrating a hardware configuration of the printer, as an example of the image output device 103. The image output device 103 includes a CPU 401, a ROM 402, a RAM 403, a communication unit 404, a printer I/F 405, a memory controller 406, a printer 407, an external memory 408, and an operation unit 409. These units are connected together via a system bus 410. The CPU 401 integrally controls constituent elements included in the image output device 103. The CPU 401 invokes a control program stored in the ROM 402 or a control program stored in the external memory, and executes processes according to the program while utilizing the RAM 403 as a work area. The CPU 401 outputs an image signal, as output information, to the printer 407 via the printer I/F 405. The CPU 401 is capable of performing the process of communicating with the client terminal 102 via the communication unit 404 and can notify internal information on the image output device 103 to the client terminal 102. The CPU 401 can also receive, via the communication unit 404, output data that is received from the client terminal 102 or the server 101 and is to be output to the printer 407. The RAM 403 functions as the main memory, a work area, and the like for the CPU 401. The memory capacity of the RAM 403 can be expanded with an optional RAM that is connected to an add-on port not illustrated. The external memory 408 is a mass storage medium such as a hard disk or an IC card. The external memory 408 is optionally connectable. In the external memory 408, font data, an emulation program, form data, information about ink to be used and types and sizes of papers to be fed, status information, and the like are stored. The operation unit 409 includes an operation panel including a display device, a touch panel, a numeric keypad, and hardware keys. The operation unit 409 receives an operational input made by the user, inputs the operational input to the CPU 401, and displays various types of information output from the CPU 401.

### Software Configuration

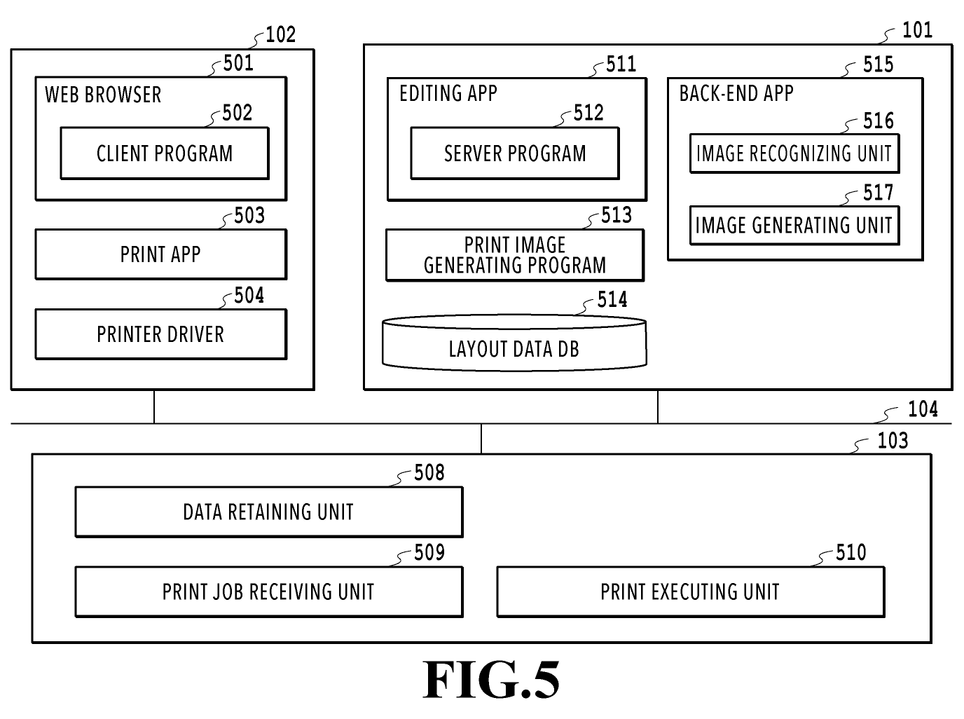

FIG. 5 is a diagram illustrating an example of the software configuration of the print system 100. As mentioned above, the server 101 or the client terminal 102 includes an editing app 511, which is an app program implementing the function of generating/editing the layout data. That is, on the install server 101, a server program 512 of the editing app 511 is installed, and on the client terminal 102, a client program 502 of the editing app 511 is installed.

In addition to the server program 512 of the editing app 511, the server 101 includes a print image generating program 513, a layout data database (DB) 514, and a back-end app 515. The back-end app 515 includes an image recognizing unit 516 and an image generating unit 517. These programs and data are stored in the ROM 202 or the external memory 210 of the server 101.

The editing app 511 is an application program for creating a new layout data item on content and editing a layout data item on content. The server 101 executes the server-side processing of the editing app 511 according to the server program 512. The CPU 201 of the server 101 invokes the server program 512 stored in the ROM 202 or the external memory 210, loads the server program 512 onto the RAM 203, and executes the server program 512. The server program 512 includes a program for executing various functions included in the editing app 511. The server program 512 also includes a program controlling a processing request and a response, and data exchanges between the server 101 and the client terminal 102. The server program 512 also includes a program controlling a processing request and a response with the print image generating program 513, the image recognizing unit 516, the image generating unit 517, and other units not illustrated. The function of the editing app 511 will be described later.

The print image generating program 513 generates a print image data in response to a request from the client terminal 102 and transmits the generated print image data to the client terminal 102.

The layout data database (DB) 514 stores layout data generated by the editing app 511, a template data item to be used by the editing app 511, image data, and the like.

### Layout Data, Template Data

A layout data item is a data item to be edited on content such as a poster. The layout data item is a data item in which information about the arrangement of one or more objects on an image plane having a predetermined size is defined. The layout data item includes format data on JPG (Joint Photographic Experts Group), PNG (Portable Network Graphics), SVG (Scalable Vector Graphics), and the like and layout information. The one or more objects arranged in the layout data item each include an image data item, a text data item, or a figure data item. Hereinafter, an object being an image data item will be referred to as an image object, an object being a text data item will be referred to as a text object, and an object being a figure data item will be referred to as a figure object. The layout data item is retained in association with information including the arrangement position, size, color, font, and attribute of each object. Furthermore, the layout data item is retained in association with additional information on identification information (ID), content type, category, and the like.

A template data item is a layout data item that is created in advance for each content type (poster, photobook, etc.) and for each category (usage, purpose, etc.). In the template data item, a provisional image object or a provisional text object may be arranged.

In the present embodiment, a procedure for newly generating a desired layout data item by the user performing editing operations on a template data item that is created in advance as a template of a poster will be described. The editing operation includes the replacement, addition, deletion, position adjustment, color adjustment, and font adjustment of an object. The template data item, which serves as the source of a layout data item to be generated by the user, may be created by a designer or a user or may be automatically generated by a generative AI (artificial intelligence) that has been trained for generating templates. Note that the editing app allows not only the editing of the template data item but also the editing of a layout data item that the user created in the past and the creation of a new layout data item by the user.

In the layout data DB 514, various types of data such as print image data of layout data, user account data, and setting information on the editing app 511 may be saved, in addition to layout data and template data. In addition, stock image data that can be arranged in a layout data item as an image object may be saved in the layout data DB 514.

The back-end app 515 executes a process in response to a request from the server program 512 of the editing app 511 and sends the result of the process back to the server program 512. The back-end app 515 includes the image recognizing unit 516, the image generating unit 517, and the like. The back-end app 515 is utilized in the process of generating a layout data item or an automatic image adding process, which is described later, in the editing app 511. The image recognizing unit 516 and the image generating unit 517 may be provided in the server 101, or may be separately provided in a plurality of servers 101. As the image recognizing unit 516 and the image generating unit 517, an image recognition service, an image captioning service, an image generation service, or the like that is provided from a server of a service provider, via the Internet, may be utilized. Alternatively, the image recognizing unit 516 and the image generating unit 517 may be included in the client terminal 102.

The image recognizing unit 516 analyzes an image data item being input (an input image), recognizes a subject included in the input image, and outputs a caption (text data item) describing the subject or the name of the subject as the result of the recognition. The image recognizing unit 516 includes a model that is built through machine learning so as to detect a subject included in the input image and output the detected subject in the form of a text data item or includes an algorithm for the model, such as You Only Look Once (YOLO). In the case of YOLO, an image recognition result including the subject included in the input image and the confidence for the subject can be output. The confidence is an index indicating the accuracy of the result of the recognition. The confidence is output for each of subjects recognized in an image. Note that the technique used in the image recognizing unit 516 is not limited to YOLO. Another known technique may be used.

The image recognizing unit 516 executes a process in response to a request from the server program 512 of the editing app 511 and sends the result of the process back to the server program 512. The image recognizing unit 516 is utilized in display control of candidate images obtained in the automatic image adding function of the editing app 511. In the present embodiment, information on a subject recognized in an image is used to control the order of arraying for displaying and arraying the candidate images. The display control of the candidate images in the automatic image adding function will be described later.

The image generating unit 517 includes an image generation model that generates and outputs an image data item on a basis of an input prompt. As a specific example of the image generation model, a machine learning model (image generative AI), such as text2img can be used. Note that the technique used in the image generating unit 517 is not limited to text2img. Another known technique may be used. The image generating unit 517 executes a process in response to a request from the server program 512 of the editing app 511 and sends the result of the process back to the server program 512. The image generating unit 517 is utilized in the process of obtaining candidate images that are candidates for an image object to be arranged in the layout data item, in the automatic image adding function of the editing app 511. The obtaining of the candidate images in the automatic image adding function will be described later.

The client terminal 102 includes a web browser 501, a print app 503, and a printer driver 504. The web browser 501 is a program implementing functions such as browsing a web site on the Internet and executing a web application, in the client terminal 102. In a case of executing the web application, the web browser 501 receives the client program 502 from the server 101 and executes the received client program 502. For example, the client program 502 of the editing app 511 is executed. The web browser 501 executes the client program 502 by interpreting HTML and a scripting language such as JavaScript. In the present embodiment, the client terminal 102 is supposed to execute the client program 502 of the editing app 511, which is a web application.

The client program 502 of the editing app 511 displays a UI screen of the editing app 511 in the web browser 501. The client program 502 also receives an operation by the user via the UI screen. The process of generating/editing the layout data item includes the creation of a new layout data item, the deletion of a layout data item, the addition or deletion of an image object or a text object to be arranged in a layout data item, the adjustment of arrangement, and the obtaining of an object (obtaining an object from a file, creating a new object). The client program 502 requests the server program 512 to perform a part or all of a received process, receives the result of the part or all of the process performed by the server program 512, and displays the result on the UI screen.

The client program 502 saves a layout data item to be processed in the RAM 303 of the client terminal 102 as a cache. Alternatively, the layout data item is saved in the layout data DB 514 of the server 101 for each client terminal 102. In a case where user accounts are provided, layout data items may be saved for the respective user accounts.

The print app 503 and the printer driver 504 are programs causing the image output device 103 to execute printing. The print app 503 obtains, from the printer driver 504, device information on the image output device 103 and printing parameters such as paper type, paper size, and print quality. The print app 503 also obtains, from the print image generating program, a print image data item into which a layout data item is rendered. The print app 503 receives the editing of print settings made by the user based on the obtained printing parameters and generates a print job including the print settings and a data item on a print image. The print job is transmitted from the client terminal 102 to the image output device 103 via a spool of the printer driver 504. Upon receiving a print instruction to print a layout data item from the user, the editing app 511 requests the server 101 to generate a print image data and obtains the print image data item as the response to the request. The print app 503 obtains the print image data, receives the print settings made by the user, generates the print job, and transmits the print job to the image output device 103 for the execution of the printing. In a case of generating the print job, the print app 503 requests the editing app 511 to generate a preview image data item on the layout data item or requests the print image generating program 513 of the server 101 to generate a print image data item.

The image output device 103 includes a data retaining unit 508, a print job receiving unit 509, and a print executing unit 510. The data retaining unit 508 retains, as the device information, information on the types and remaining amounts of inks provided in the image output device 103, information on the types, sizes, and the like of registered papers and papers to be fed, status information on the image output device 103, status information on a print job, and the like. The print job receiving unit 509 receives the print job transmitted from the client terminal 102. The print executing unit 510 causes the printer 407 of the image output device 103 to execute the print processing according to the print job.

Note that, in a case where an image output device 103 to be utilized for the printing is determined in advance in the print system 100, the client terminal 102 or the server 101 may obtain the device information on the image output device 103 in advance and retain the device information in association with the layout data item. Thus, the creation of a layout data item suitable for the image output device 103 can be more smoothly executed by, for example, making the paper type and size of a print product that can be output by the image output device 103, available inks, and the like selectable and excluding in advance settings that disable the output.

### Editing App

Next, a functional configuration of the editing app 511 will be described.

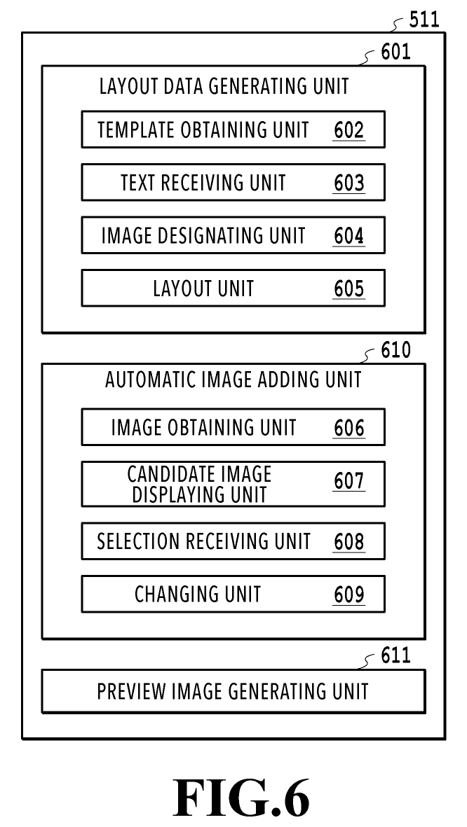

FIG. 6 is a diagram illustrating the functional configuration of the editing app 511. As mentioned above, the editing app 511 is an application program assisting the user in creating content such as a poster. As illustrated in FIG. 6, an editing app 511 in a first embodiment includes a layout data generating unit 601, an automatic image adding unit 610, and a preview image generating unit 611. The layout data generating unit 601 includes a template obtaining unit 602, a text receiving unit 603, an image designating unit 604, and a layout unit 605. The automatic image adding unit 610 includes an image obtaining unit 606, a candidate image displaying unit 607, a selection receiving unit 608, and a changing unit 609. These functional units are implemented by the CPU of the server 101 or the client terminal 102 invoking a program stored in its ROM or memory and executing processes according to the program.

The layout data generating unit 601 executes the process of generating the layout data item. In the process of generating the layout data item, the layout data generating unit 601 obtains a template data item that fits conditions on a basis of information (template designation information, content type, category, text character count, image count, and the other types of information) received from the user. The layout data generating unit 601 lays out (arranges) one or more texts and one or more images on the obtained template data item. As a result, a new layout data item is generated. The layout data generating unit 601 generates the layout data item through the processes executed by the template obtaining unit 602, the text receiving unit 603, the image designating unit 604, and the layout unit 605.

The template obtaining unit 602 obtains a template data item that serves as the source of the layout data item to be generated. The template obtaining unit 602 may receive the designation of a template from the user, or may receive an input of information from the user and obtain a template data item that fits conditions from the layout data DB 514 on a basis of the received information. For example, in a case where "poster" is designated as the content type, and "eating and drinking" is designated as the category, the template obtaining unit 602 obtains a template of a poster used for the usage related to eating and drinking from the layout data DB 514. The template obtaining unit 602 may obtain a template data item that fits conditions including a text character count, an image count, and the other types of information received from the user.

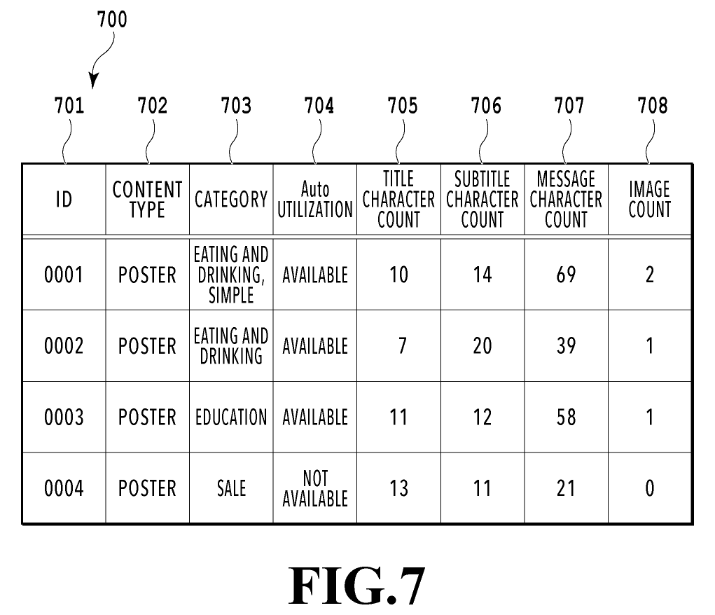

FIG. 7 is a table showing an example of a data configuration of a template information item 700 associated with a template data item. Template data items stored in the layout data DB 514 each include a format data item on a template image, such as JPG, PNG, or SVG, and the template information item 700. The template information item 700 includes identification information (ID) 701, a content type 702, a category 703, Auto utilization 704, a title character count 705, a subtitle character count 706, a message character count 707, and an image count 708 of a template data item. The template information item 700 is defined for each template data item. To an entry of the Auto utilization 704, available or not available is set. "Available" indicates that the template data item is available in an auto design function. "Not available" indicates that the template data item is not available in the auto design function. The auto design function is a function of the editing app selecting a template data item on a basis of a few input information items input by the user and arranging one or more texts and one or more images on the template data item on a basis of the input information, thus generating a new layout data item. To entries of the title character count 705, the subtitle character count 706, and the message character count 707, character counts (the lengths of texts) that can be input into a title object, a subtitle object, and a message object are set. The image count 708 is the number of image data items that can be arranged in the template data item.

The example in FIG. 7 shows template information items 700 the content type 702 of which is "poster." For example, in the template information item of an ID "0001," "eating and drinking/simple" is set to its entry of the category 703, and "available" is set to its entry of the Auto utilization 704. In addition, "10" is set to the title character count, "14" is set to the subtitle character count, "69" is set to the message character count, and "2" is set to the image count. Therefore, this template data item is available in the auto design function and allows up to two image objects to be arranged. In a case where the user prepares no image, candidate images are presented through the utilization of the automatic image adding function described later. From among the candidate images, the user can select one or more images to be arranged in the template data item.

Refer back to the description of FIG. 6. The text receiving unit 603 (character string receiving unit) receives an input of at least one character string (text data item) to be arranged in the template data item. In the present embodiment, an example in which the text receiving unit 603 receives inputs of text data items from the user will be described. Note that the text data items may be text generated by a text generation model. For example, inputs of text objects to be arranged as the title, subtitle, and message of the template data item are received on a basic settings screen, which is a UI screen of the editing app.

The image designating unit 604 receives the designation of one or more image data items to be arranged in the template data item, from the user. The image designating unit 604 may receive the designation of a source location of an image file from the user or may receive the selection made by the user from among the candidate images obtained by the automatic image adding function. In the following description, an image data item that is designated by the image designating unit 604 as an image data item to be arranged in the template data item will also be referred to as a designated image. The upper limit count of designated images is an image count that is set in the template information item 700 in advance. Note that the number of designated images is optional in a case where the user freely generates a layout data item without the use of the template data item. Note that a predetermined upper limit count may be provided in advance.

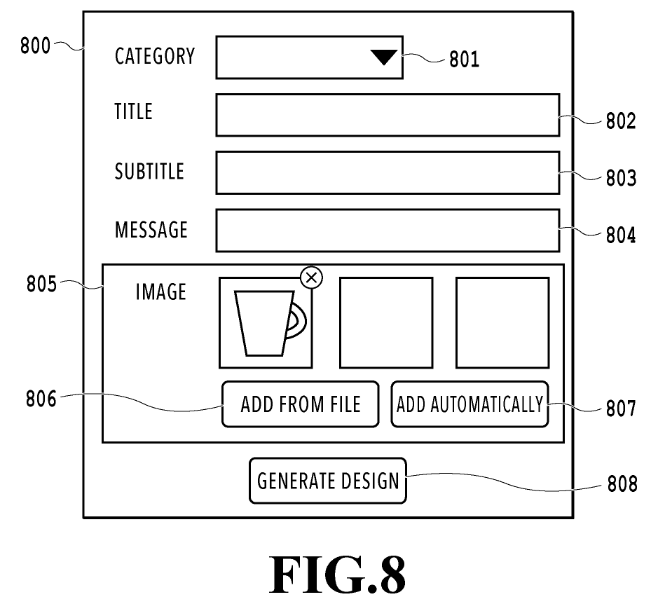

FIG. 8 is a diagram illustrating an example of a basic settings screen 800, which is one of user interface (UI) screens of the editing app. The basic settings screen 800 is displayed on the display device 309 of the client terminal 102 on a basis of the display data item transmitted from the server 101. As illustrated in FIG. 8, the basic settings screen 800 is provided with a category selection region 801, a title input region 802, a subtitle input region 803, a message input region 804, an image designation region 805, and a design generation button 808. The image designation region 805 is provided with an "ADD FROM FILE" button 806 and an "ADD AUTOMATICALLY" button 807.

The category selection region 801 is a region for receiving the selection of the category (usage, purpose) of a poster that the user intends to create. For example, the category selection region 801 displays categories such as eating and drinking, education, and sale, in the form of a drop-down list. In the list of the categories, for example, information items on categories that are set in template information items on template data items stored in the layout data DB 514 are extracted and displayed. Alternatively, a category list prepared in advance may be displayed. For example, the editing app may extract in advance information items on categories from a plurality of template data items stored in the layout data DB 514 and save the information items as the category list, and may display the category list in the category selection region 801 in the form of a list. Each of the template data items may be associated with one category or may be associated with a plurality of categories. A category designated in the category selection region 801 is referred to by the template obtaining unit 602 of the editing app and utilized to determine a template data item.

The title input region 802 is a region for inputting a character string (text) to be arranged as a title object in the template data item. A text input into the title input region 802 by the user is reflected (arranged) in the template data item in the form of a title object. The subtitle input region 803 is a region for inputting a text to be arranged as a subtitle object in the template data item. The message input region 804 is a region for inputting a text of a text object that is to be arranged in the template data item and is other than the title and the subtitle. Note that, in the present embodiment, an input into any one of the title input region 802, the subtitle input region 803, and the message input region 804 is treated as required. The title input region 802, the subtitle input region 803, and the message input region 804 constitute a user interface for the text receiving unit 603 of the editing app. The text receiving unit 603 receives text data items input into these regions.

The image designation region 805 is a region for displaying one or more designated images that are designated as image data items to be arranged in the template data item. In the following description, an image that is designated as an image data item to be arranged in the template data item will be referred to as a designated image. A thumbnail of the designated image is displayed in the image designation region 805. The addition of an image is performed by the addition through a drag-and-drop operation on the image from the outside of the application into the frame of the image designation region 805. Alternatively, an image may be added by the user designating a desired file on a file search dialog that is displayed in response to a press of the "ADD FROM FILE" button 806. Furthermore, in a case where the "ADD AUTOMATICALLY" button 807 is pressed, the automatic image adding function is enabled, and the automatic image adding process is started.

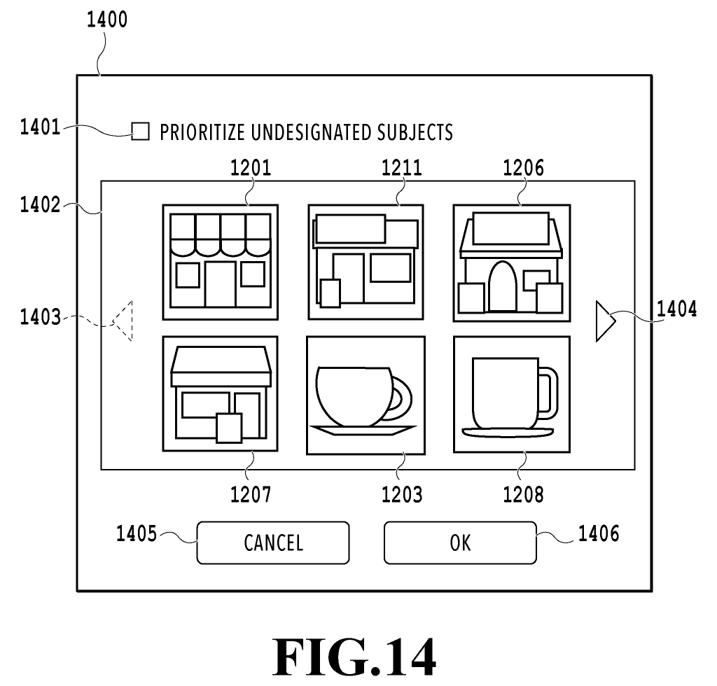

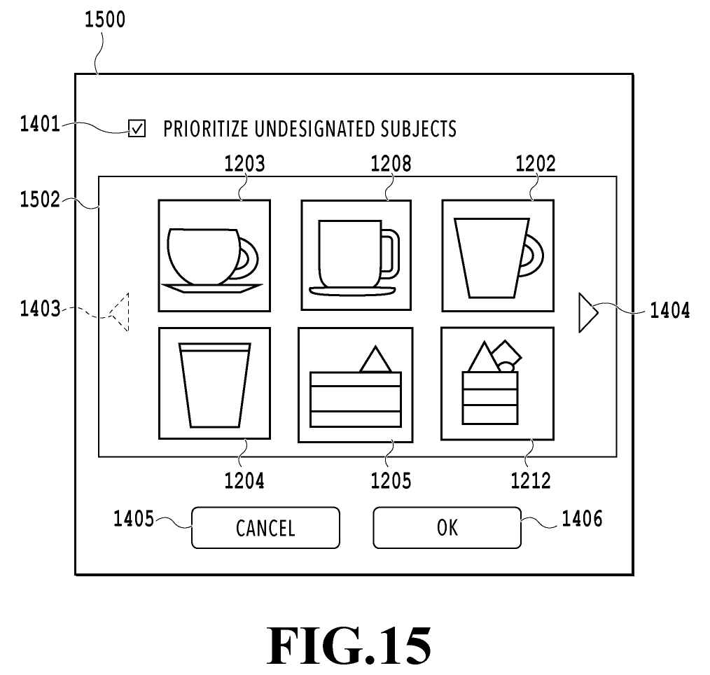

In the automatic image adding process, the image obtaining unit 606 of the editing app obtains a plurality of candidate images on a basis of keywords extracted from the text data item being input on the basic settings screen 800 and displays the plurality of candidate images on a candidate image selection screen (FIG. 14 and FIG. 15). The display control of the candidate images on the candidate image selection screen is performed through the processing by the candidate image displaying unit 607 and the changing unit 609. The selection receiving unit 608 of the editing app receives a selection by the user from among the candidate images displayed on the candidate image selection screen. An image selected from among the candidate images by the user is added to the image designation region 805 as the designated image.

An image that is allowed to be added to the image designation region 805 may be defined such that only specific image formats such as JPEG and PNG are permitted. In this case, the addition of an image data item in a format other than the specific formats mentioned above is disabled. The number of images allowed to be input may be restricted by the editing app to an upper limit set to a predetermined number, for example, three. In this case, in a case where images are added to the image designation region 805 to the upper limit, the "ADD FROM FILE" button 806 and the "ADD AUTOMATICALLY" button 807 are controlled so as to be made inactive. In addition, the drag-and-drop of an image into the image designation region 805 is controlled so as not to be reflected. The thumbnail image of a designated image added to the image designation region 805 is displayed to allow the user to view the designated image. In addition, the thumbnail image may be provided with a deletion mark to allow the designation of the corresponding image to be cancelled by a press of the deletion mark.

A press of the design generation button 808 causes the layout unit 605 of the layout data generating unit 601 to start the process of generating the layout data item. Note that the design generation button 808 may be controlled such that the design generation button 808 is displayed in an inactive state and cannot be pressed in a case where a required input field of the basic settings screen 800 is blank. For example, in a case where the title input region 802 is defined as the required input field and is blank, the design generation button 808 is displayed in the inactive state. In this case, the process cannot be carried out. Note that any field may be defined as the required input field.

In the process of generating the layout data item, the layout unit 605 generates the layout data item using the template data item obtained by the template obtaining unit 602, the text data items received by the text receiving unit 603, and the designated image designated by the image designating unit 604. The layout unit 605 arranges the text data items received by the text receiving unit 603 at predetermined positions in the template data item as text objects. For example, a text data item input as the title is arranged in a region in the template data item that is given a title attribute. A text data item input as the subtitle is arranged in a region in the template data item that is given a subtitle attribute. A text data item input as the message is arranged in a region in the template data item that is given a message attribute. Although it is assumed that each of the text data items is arranged in a font, color, and size designated in the template data item, the font, color, and size may be designated by the user. The layout unit 605 also arranges the image data item designated by the image designating unit 604 as an image object having a predetermined size in a region in the template data item that is given an image attribute. Thus, the layout data item is generated. Note that the layout unit 605 may adjust the position, size, color, and font of each object, perform cropping or other editing on an image, and perform processing, automatically or based on an operation by the user.

In a case where the "ADD AUTOMATICALLY" button 807 is pressed in the basic settings screen 800 of the editing app 511, that is, in a case where the automatic image adding function is set to be enabled, the image designating unit 604 requests the automatic image adding unit 610 to execute the automatic image adding process. In the automatic image adding process, the automatic image adding unit 610 extracts keywords from one or more text data items input by the user and obtains candidate images related to the keywords. The automatic image adding unit 610 obtains the candidate images while causing the image obtaining unit 606, the candidate image displaying unit 607, the selection receiving unit 608, and the changing unit 609 to execute their processing, and displays the candidate images in a selectable manner.

The image obtaining unit 606 obtains an image data item including a subject related to the text data items received by the text receiving unit 603. Specifically, the image obtaining unit 606 extracts a term serving as the keywords from the text data items received by the text receiving unit 603 and obtains candidate images that match the keywords. Hereinafter, the keywords will be referred to as extracted keywords.

To determine the extracted keywords, the image obtaining unit 606 performs morphological analysis on the text data items to extract nouns and determines, on a basis of the frequencies of words, words having high frequencies as the extracted keywords. Alternatively, the image obtaining unit 606 may use a known keyword extraction technique to extract a predetermined number of words as keywords. Examples of the keyword extraction technique include YAKE! (https: //www.sciencedirect.com/science/article/abs/pii/S0020025519308588). YAKE! is an unsupervised keyword extraction method that selects the most relevant keyword of a text on a basis of statistical text features extracted from documents. Note that the keyword extraction technique is not limited to this. A machine learning algorithm may be used to extract the keywords.

In a case where the morphological analysis cannot be performed, or a case where the morphological analysis can be performed but fails to extract nouns, words corresponding to the category input into the category selection region 801 of the basic settings screen 800 may be set as the extracted keywords. In the case where the morphological analysis cannot be performed, or the case where the morphological analysis can be performed but fails to extract nouns, and further in a case where the category is not input, the situation that makes the automatic image adding process inexecutable may be displayed so as to be visible to the user. For example, the "ADD AUTOMATICALLY" button 807 of the basic settings screen 800 may be displayed in an inactive state so that the button 807 cannot be pressed, or the sentence to the effect that the automatic image adding process is inexecutable may be displayed in the basic settings screen 800 or as a pop-up message.

The image obtaining unit 606 searches a collection of stock images included in the editing app, a stock photo service being an external service, or the like, for images that match the extracted keywords and obtains the images. Alternatively, the image obtaining unit 606 requests the image generating unit 517 to generate images related to the extracted keywords and obtains image data items generated by the image generating unit 517. In this case, the image obtaining unit 606 generates a prompt including the extracted keywords and requests the image generation from the image generating unit 517. The number of images obtained by the image obtaining unit 606 is any number greater than or equal to the number of images that can be arranged in the template data item. The upper limit value of the number of images to be obtained may be set in advance.

The image obtaining unit 606 determines the priorities of the extracted keywords. The priorities of the extracted keywords are utilized by the candidate image displaying unit 607 to determine the order of arraying candidate images. The image obtaining unit 606 determines the priorities of the extracted keywords in descending order of extraction count. The priorities are priority ranks. The highest priority is the first priority rank, and the priorities decrease in the order the second, third, .... In the present embodiment, the image obtaining unit 606 determines the priorities of the extracted keywords on a basis of the frequencies of the extracted keywords. First, the image obtaining unit 606 sets the priorities of the extracted keywords in descending order of their frequencies. The priorities of extracted keywords having the same frequency are determined in accordance with the attributes of the extracted keywords. The attributes are information on an input region into which each extracted keyword has been input. In the present embodiment, priorities of the extracted keywords having the same frequency are determined such as the first for the title input region, the second for the subtitle input region, and the third for the message input region. For extracted keywords having priorities that are determined in this manner to be at the same rank, their priorities are determined in the order in which the extracted keywords appear in the basic settings screen. Note that the method of determining the priorities of the extracted keywords is an example. The priorities of the extracted keywords may be determined under a rule different from the rule mentioned above.

The candidate image displaying unit 607 arrays and displays the plurality of candidate images so as to allow the user to make a selection from among the plurality of candidate images. The candidate images are the image data items obtained by the image obtaining unit 606 by means of the automatic image adding function. The candidate images include at least either image data items obtained through the search or image data items generated by the image generating unit 517 (generated images). For each of all the candidate images obtained by the image obtaining unit 606, the candidate image displaying unit 607 analyzes the candidate image, obtains a subject information item and a confidence information item as the analysis result, and saves the subject information item and the confidence information item in association with the candidate image. The subject information item is a text data item indicating a subject recognized from an image, and the confidence information is a numeric data item that is an index indicating the accuracy of the result of the recognition of the subject. The candidate image displaying unit 607 requests the image recognizing unit 516 to recognize a subject included in each candidate image to obtain the subject information item and the confidence information item.

The candidate image displaying unit 607 also determines the priorities of the candidate images for the order of arraying. Specifically, the candidate image displaying unit 607 determines the priorities on a basis of the priorities of the extracted keywords and subject information items on the candidate images. The candidate image displaying unit 607 also determines the priorities of the candidate images for the order of arraying, with the information on confidence taken into account, as desired.

The candidate image displaying unit 607 makes the order of arraying the candidate images correspond to the priorities of the keywords in a case where the subject information items recognized from the candidate images are included in the extracted keywords. That is, the candidate image displaying unit 607 links the candidate images to extracted keywords that match subject information items recognized from the candidate images. The candidate image displaying unit 607 then determines the priorities of the extracted keywords as the priorities of the candidate images.

For extracted keywords having the same priority, the candidate image displaying unit 607 further determines the priorities of corresponding candidate images on a basis of confidence, which is an index indicating the accuracy of the result of the recognition of a subject. That is, in a case where a plurality of candidate images are linked to the same extracted keyword, the candidate image displaying unit 607 sets the priority of a candidate image having a greater value of confidence among the plurality of candidate images to be higher.

In a case where subject information items recognized from candidate images are not included in the extracted keywords, the candidate image displaying unit 607 determines the order of arraying the candidate images on a basis of the number of candidate images having subject information items of the same type. The subject information items of the same type means that texts describing the subject information items match or partially match one another. For candidate images that are linked to none of the extracted keywords, that is, candidate images in which no subjects matching the extracted keywords are recognized, the candidate image displaying unit 607 groups the candidate images such that candidate images having the same subject information item belong to the same group. Then, the priority of a group including a large number of images is set to be high. Note that the priorities of candidate images linked to none of the extracted keywords are set to be lower than the priorities of the candidate images linked to the extracted keywords. The priorities of the candidate images are determined in this manner. Note that the method of determining the priorities of the candidate images is an example, and the priorities of the candidate images may be determined by a method different from the determining method mentioned above.

On a basis of the determined priorities, the candidate image displaying unit 607 arrays and displays the candidate images. The candidate image displaying unit 607 causes the display device 309 of the client terminal 102 to display the candidate image selection screen in such a manner as to array and display, in a candidate image display region of the candidate image selection screen, the candidate images in the order in which a candidate image having a high priority is at a forward position and a candidate image having a low priority is at a backward position. Thus, a candidate image that includes a subject corresponding to an extracted keyword with the highest priority and has the highest confidence in image recognition is displayed at a foremost position. Being displayed at a forward position means being at a display position of a high priority in the candidate image display region of the candidate image selection screen. The priority of the display position is assumed to be set in advance. For example, in the candidate image display region, it is assumed that the priorities are set such that an image located on the left has a higher priority than an image located on the right within the same tier. In a case where the candidate image display region includes a plurality of rows, it is assumed that the priorities are set such that an upper image has a higher priority than a lower image. In a case where the candidate image display region includes a plurality of pages, the first page has the highest priority, and the priority decreases for the second page, the third page, ... as the page number increases. Note that the priorities of the display positions can be changed as appropriate in accordance with the configuration of the screen. In the present embodiment, a display position of a higher priority is expressed as the "forward position," and a display position of a lower priority is expressed as the "backward position."

In a case where a subject seen in a candidate image matches an extracted keyword having a high priority, the candidate image is displayed at a forward position, making it easy for the user to select the candidate image. In addition, a plurality of candidate images are arrayed by extracted keywords, that is, in groups based on candidate images including a subject of the same type. This allows the user to compare a plurality of candidate images including a subject of the same type, for selecting an image.

The selection receiving unit 608 receives a selection made by the user from among the candidate images that are arrayed and displayed by the candidate image displaying unit 607. An image the selection of which is received by the selection receiving unit 608 is brought into a selected state. In a case where a confirming operation is performed on the image in the selected state, the image is brought into a state of being designated as a designated image to be arranged in the layout data item. The selection receiving unit 608 adds the designated image to the image designation region in the basic settings screen. Note that the image designating unit 604 counts the number of designated images. In a case where the count value of the designated images is one or more, and a "prioritize undesignated images" function is set to be enabled, the changing unit 609 changes the order of arraying the candidate images.

In a case where the count value of the designated images is zero, that is, in a state where none of the designated images has been selected, the candidate images are displayed on a basis of the priorities of the candidate images that are determined on a basis of the priorities of the extracted keywords, the subject information items, and the confidence information items, as mentioned above. In a case where the count value of the number of times a selection is made from among the candidate images is one or more, that is, for the second or subsequent designated image, the candidate images are displayed in a method of displaying by the changing unit 609.

The changing unit 609 changes the order of arraying the candidate images such that a candidate image including a first subject, which is a subject of the same type as a subject recognized from a specific image (a first candidate image), is displayed at a farther backward position than a candidate image not including the first subject (a second candidate image). In the first embodiment, the specific image is a designated image. The designated image includes any one of an image selected from among the candidate images by the user and an image that is not included in the candidate images and designated by the user (a designated image added by the user through the designation of a file). In the first embodiment, the changing unit 609 changes the order of arraying the candidate images in a case where an image is selected from among the candidate images by the user and added as the designated image or a case where the designated image is added to the image designation region through the designation of a file by the user.

In other words, the changing unit 609 changes the order of arraying the candidate images such that the second candidate image including a subject information item different from the subject information item on the designated image is prioritized over the first candidate image including a subject information item matching the subject information item on the designated image, and displayed at a forward position. Accordingly, undesignated candidate images are preferentially displayed.

For example, assume that candidate images including "cafe" as their subjects (a cafe image group), candidate images including "coffee" as their subjects (a coffee image group), and candidate images including "cake" as their subjects (a cake image group) are arrayed in this order through the processing by the candidate image displaying unit 607. In a case where the user designates one image from the coffee image group, the priority of the coffee image group is changed by the changing unit 609 to be lower than the priorities of the cafe image group and the cake image group. Thereafter, the changing unit 609 sorts the candidate images in the order of the priorities. Thus, the coffee image group, which includes subjects of the same type as the subject of the designated image, is arrayed at a farther backward position than the cafe image group and the cake image group. As seen from the above, the candidate images are displayed such that the priorities of candidate images including undesignated subjects are higher than the priorities of candidate images including the subject of the designated image, making it easy for the user to select an image including the undesignated subjects in the second or subsequent image designation.

The preview image generating unit 611 generates a preview image into which the layout data item generated by the layout data generating unit 601 is rendered. The preview image is displayed on a preview screen.

### Layout Data Generating Process

Hereinafter, a layout data generating process executed using the auto design function of the editing app will be described. Here, an example in which content to be created is a poster will be described.

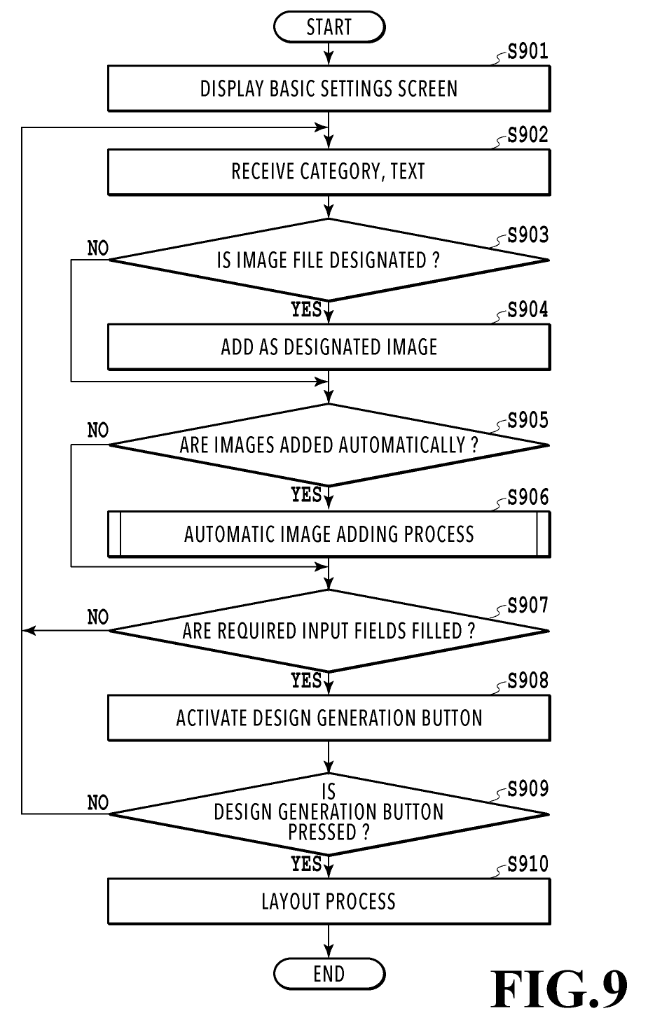

FIG. 9 is a flowchart illustrating a flow of the layout data generating process. The process illustrated in FIG. 9 is included in at least any one of the server program and the client program of the editing app. The program is invoked by the CPU of the server 101 or the CPU of the client terminal, loaded onto the RAM, and executed by the CPU. In a case where the user using the client terminal 102 designates a poster as content to be created on a menu screen displayed after the editing app is launched, a creation start instruction is transmitted to the server 101. Upon receiving the creation start instruction of the poster, the server 101 starts the flowchart illustrated in FIG. 9. In the following description, the symbol "S" denotes a step. The CPUs of the server 101 and the client terminal 102 execute their processing according to the programs to function as the layout data generating unit 601, the template obtaining unit 602, the text receiving unit 603, the image designating unit 604, and the layout unit 605.

In S901, the CPU 201 of the server 101 (the layout data generating unit 601) transmits the display data item for displaying the basic settings screen 800 illustrated in FIG. 8 to the client terminal 102 to cause the client terminal 102 to display the basic settings screen 800. Upon receiving the display data item transmitted from the server 101, the CPU 301 of the client terminal 102 displays the basic settings screen 800 on the display device according to the display data item. The CPU 301 of the client terminal 102 receives inputs into the input regions made by the user and transmits input data items to the server 101. The layout data generating unit 601 of the server 101 receives the data items transmitted from the client terminal 102. The displaying of the screen and the reception of the input data items on the screen also apply likewise to the following description.

In S902, the layout data generating unit 601 receives an input of a category in the category selection region 801 of the basic settings screen 800. The text receiving unit 603 receives inputs of character strings (texts) into the title input region 802, the subtitle input region 803, and the message input region 804. The layout data generating unit 601 and the text receiving unit 603 causes the RAM to retain the input text data items.

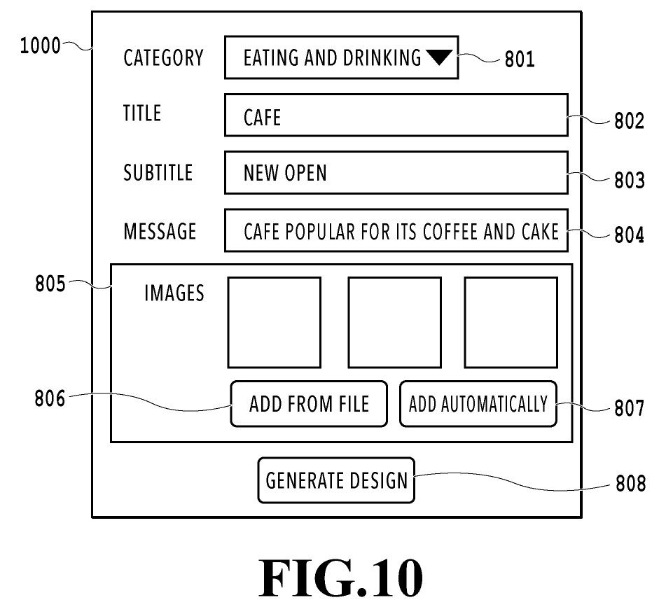

FIG. 10 is a diagram illustrating an example of inputs into the basic settings screen made by the user. In a basic settings screen 1000 illustrated in FIG. 10 illustrates a state where texts are input into the category selection region 801, the title input region 802, the subtitle input region 803, and the message input region 804 for the purpose of creating a poster of a cafe. Note that, in FIG. 10, the same regions and buttons as in FIG. 8 are given the same reference signs.

As illustrated in FIG. 10, "EATING AND DRINKING" is selected as the category, and the character string "cafe" is input into the title input region 802. The character string "NEW OPEN" is input into the subtitle input region 803, and the character string "Cafe popular for its coffee and cake" is input into the message input region 804. The basic settings screen 1000 in FIG. 10 is a state where no designated image is added to the image designation region 805.

In a case where the user has prepared an image data item to be put on the poster, the file of a desired image data item can be designated through an operation on the "ADD FROM FILE" button 806. In a case where the user has prepared no image data to be put on the poster, an operation on the "ADD AUTOMATICALLY" button 807 enables the automatic image adding function, and a plurality of candidate images are obtained by the editing app.

In S903, the layout data generating unit 601 determines whether an image file has been designated. The layout data generating unit 601 determines that an image file has been designated in a case where a drag-and-drop operation on an image into the frame of the image designation region 805 has been performed, or the operation of designating the image file has been performed through the operation on the "ADD FROM FILE" button 806. In a case where the layout data generating unit 601 determines that an image file has been designated, the layout data generating process proceeds to S904. In a case where the layout data generating unit 601 does not determine that an image file has been designated, the layout data generating process proceeds to S905.

In S904, the image designating unit 604 causes the RAM 302 to retain, as a designated image or designated images, the image data item added into the frame of the image designation region 805, or the image data item or identification information on the image data item designated from the "ADD FROM FILE" button 806. The image designating unit 604 counts the number of the designated images. A designated image can be added until the number of designated images exceeds a maximum number of designated images (e.g., 3).

In S905, in a case where the "ADD AUTOMATICALLY" button 807 is operated by the user, the layout data generating process proceeds to S906.

In S906, the automatic image adding unit 610 executes the automatic image adding process. In the automatic image adding process, candidate images that fit the input information items being input on the basic settings screen are obtained, and the candidate image selection screen is displayed so as to be selectable by the user. A candidate image selected on the candidate image selection screen by the user is added to the image designation region 805 as the designated image. The automatic image adding process will be described later. Note that the image designating unit 604 also counts the number of images added to the image designation region 805 through the automatic image adding process, as designated images. In a case where the number of designated images exceeds a predetermined maximum number, the editing app may perform control to bring the "ADD FROM FILE" button and the "ADD AUTOMATICALLY" button into an inactive state so that no designated image can be added. In a case where the number of designated images becomes less than the maximum number due to, for example, the deletion of an image from the image designation region 805, the addition of a designated image is allowed again. In a case where the "ADD AUTOMATICALLY" button 807 is not operated, the layout data generating process proceeds to S907.

In S907, the layout data generating unit 601 checks whether all required input fields are filled. In the present embodiment, the required input fields are assumed to be the title input region 802 of the basic settings screen 800. In a case where a text is input into the title input region 802, the layout data generating unit 601 determines that all the required input fields have been filled, and the layout data generating process proceeds to S908. In a case where any of the required input fields is blank, the layout data generating process returns to S902. Note that the required input fields are not limited to this example. Any condition may be set for the required input fields, such as further inclusion of the designation of at least one designated image.

In S908, the layout data generating unit 601 activates the design generation button of the basic settings screen to bring the design generation button into an operable state.

In S909, the layout data generating unit 601 determines whether the design generation button has been pressed. In a case where the design generation button is not pressed, the layout data generating process returns to S902. In a case where the design generation button has been pressed, the layout data generating unit 601 executes a layout process.

In the layout process, the layout unit 605 obtains a template data item suitable for the input information items that are input by the user on the basic settings screen 1000, from the layout data DB 514. The layout unit 605 also arranges the text data items received by the text receiving unit 603 at predetermined positions in the template data item as text objects. The layout unit 605 also arranges the designated image or designated images received by the image designating unit 604 at predetermined positions in the template data item as image objects. Thus, the layout data item is generated. The layout unit 605 causes the client terminal 102 to display the generated layout data item. Note that the layout unit 605 may adjust the position, size, color, and font of each object and perform cropping or other processing on an image, according to an operation by the user. In a case where a preview instruction is input, the preview image generating unit 611 generates a preview image of the layout data item and causes the client terminal to display the preview image. In a case where an instruction to save the layout data item is input, the layout data item is saved in the layout data DB 514. The generated layout data item can be printed by the image output device 103 after being converted into a print image data through the processing by the print app 503 and the print image generating program 513.

### Automatic Image Adding Process

Hereinafter, the automatic image adding process executed in the automatic image adding function of the editing app will be described. The automatic image adding process is the process executed in S906 of the layout data generating process in FIG. 9. The automatic image adding process is started in response to a press of the "ADD AUTOMATICALLY" button 807 in the basic settings screen.

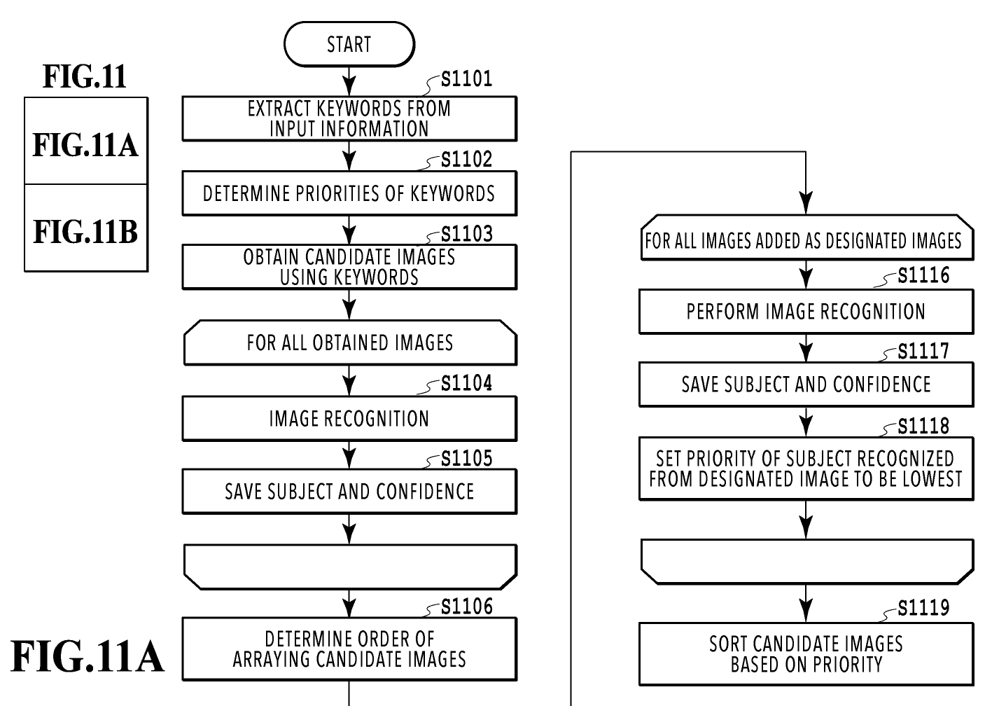

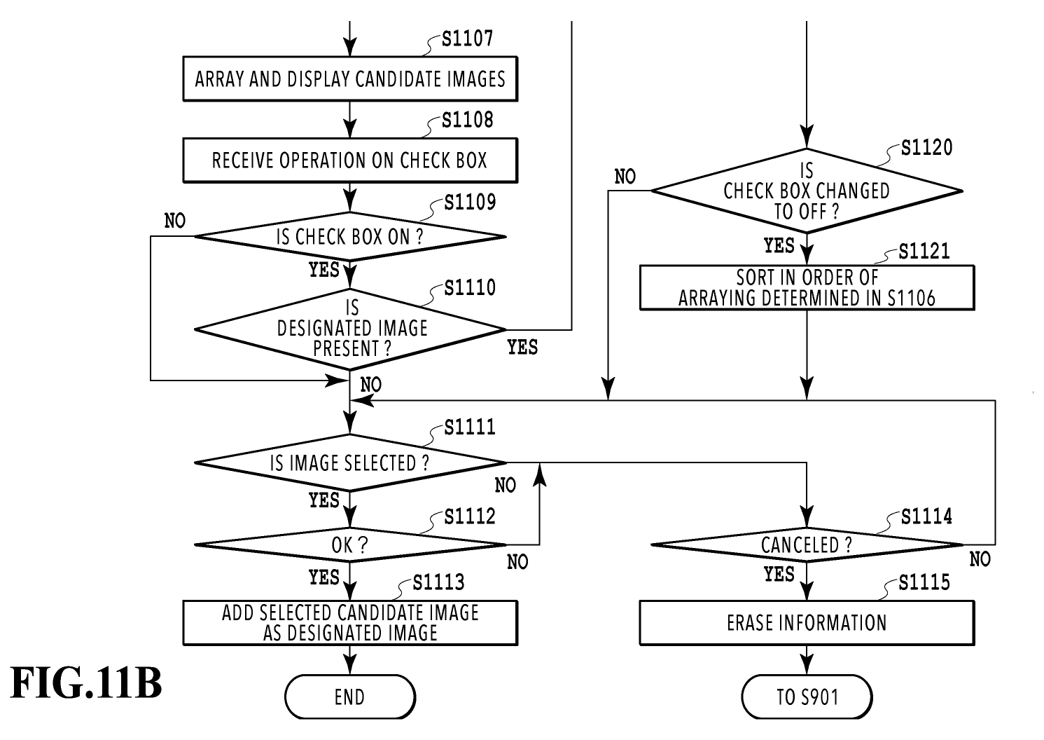

FIG. 11A and 11B are totally a flowchart illustrating a flow of the automatic image adding process. The process illustrated in the flowchart in FIG. 11A and 11B are included in at least any one of the server program and the client program of the editing app. The program is invoked by the CPU of the server 101 or the CPU of the client terminal, loaded onto the RAM, and executed by the CPU. In a case where the "ADD AUTOMATICALLY" button 807 is pressed in a state where a character string (text) is input on the basic settings screen displayed on the client terminal 102, the server 101 starts the process illustrated in this flowchart. The CPUs of the server 101 and the client terminal 102 execute their processing according to the programs to function as the automatic image adding unit 610, the image obtaining unit 606, the candidate image displaying unit 607, the selection receiving unit 608, and the changing unit 609.

In S1101, the automatic image adding unit 610 obtains text data items input into the title input region 802, the subtitle input region 803, and the message input region 804 of the basic settings screen and extracts keywords from the text data items. The keywords that have been extracted will be referred to as extracted keywords. The extracted keywords are text data items to be utilized for searching for or generating candidate images.

In S1102, the automatic image adding unit 610 determines the priorities of the extracted keywords. The priorities of the extracted keywords are used for controlling the order of arraying candidate images. In the present embodiment, the automatic image adding unit 610 determines priorities of the extracted keywords on a basis of their frequencies. The automatic image adding unit 610 also determines the priorities of the extracted keywords using the attributes of the input regions or information on the order of appearance. For example, in the input example in FIG. 10, the keyword "cafe" is extracted twice, the keyword "coffee" is extracted once, and the keyword "cake" is extracted once. First, on a basis of their frequencies, the priority of the keyword "cafe" is determined to be first. The priorities of "coffee" and "cake" having the same frequency are determined on a basis of the priorities of the attributes of the texts (the input regions). In a case of this example, both are input into the same message input region, and thus the priority of a keyword that appears earlier in the order of appearance in the input region is set to be high. As a result, the priority of "coffee" is determined to be second, and the priority of "cake" is determined to be third. Note that the method of determining the priorities is an example and is not limited to this method.

In S1103, the automatic image adding unit 610 uses the extracted keywords to obtain candidate images. The candidate images are images that are candidates for a designated image. Images related to the extracted keywords are obtained as the candidate images. In the first embodiment, the image obtaining unit 606 obtains, as the candidate images, images related to "cafe," which is the extracted keyword having the highest priority. In the present embodiment, images related to an extracted keyword include images that are searched for using the extracted keyword or generated images generated by an image generation model receiving a prompt that is generated using an extracted keyword. Although, in the first embodiment, an example in which candidate images are obtained using one extracted keyword that has the highest priority will be described, the number of extracted keywords used to obtain the candidate images is not limited to one. The number may be more than one. In a case where more than one extracted keywords are used, the extracted keywords are selected and used to obtain candidate images in descending order of priority.

The image obtaining unit 606 searches for images using the extracted keyword. A search target is stock image data saved in the layout data DB 514 in the print system 100, image data provided in a stock photo service that is present outside the print system 100, or the like. The image obtaining unit 606 also obtains generated images generated using an image generation technique as the candidate images. The print system 100 may include the image generating unit 517 that generates an image from a text, or an image generation service that is present outside the print system 100 may be utilized. The image obtaining unit 606 generates a text prompt including the extracted keyword extracted in S1101 and transmits a request to generate a prompt and an image to the image generating unit 517 or the image generation service. The image obtaining unit 606 then obtains the generated images that are generated by the image generating unit 517 or the image generation service using the prompt.

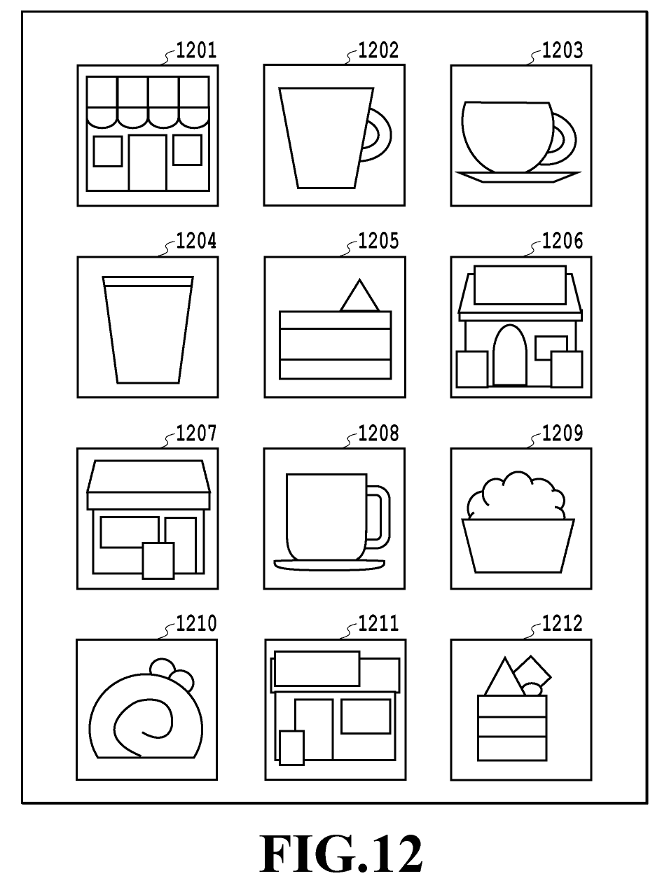

FIG. 12 is a diagram illustrating an example of a plurality of candidate images obtained in S1103. In the example illustrated in FIG. 12, cafe images 1201, 1206, 1207, and 1211, coffee images 1202, 1203, 1204, and 1208, and cake images 1205, 1209, 1210, and 1212 are obtained as images related to the extracted keyword "cafe." Note that the number of images to be obtained may be restricted to a predetermined number (e.g., 12) to prevent performance from being affected by data amount and processing time.

S1104 and S1105 constitute a loop process that targets all the candidate images obtained in S1103. The automatic image adding unit 610 executes the process of S1104 and S1105 for each of the candidate images obtained in S1103.

In S1104, the automatic image adding unit 610 performs image recognition on an image obtained in S1103. As an image recognition technique, for example, a machine learning model that can use YOLO or the like can be used as mentioned above. In the case of YOLO, a recognition result including a subject seen in the input image and the confidence for the subject can be output. The automatic image adding unit 610 inputs the candidate image, which is a recognition target, into the image recognizing unit 516 or an image recognition service and asks the image recognizing unit 516 or an image recognition service to output a subject seen in the candidate image and a confidence as an image recognition result. As the image recognition result, for example, an image recognition result such as "coffee 90%, book 60%" is output from a given candidate image. From another candidate image, an image recognition result such as "coffee 80%, desk 70%" is output. The text data items such as coffee, book, and desk are information items indicating subjects, and numeric data items such as 90% and 60% indicate confidences.

In S1105, the automatic image adding unit 610 links the information indicating a subject and a confidence of the subject that are obtained as the image recognition result, to the candidate image, and stores them. In the following description, the information indicating the subject will be referred to as subject information. The subject information is a text data item. In a case where a plurality of subjects are recognized in one candidate image, the automatic image adding unit 610 links a subject information item on a subject having the highest confidence to the candidate image and stores them. In addition to this, the automatic image adding unit 610 may link subject information items on subjects other than the subject having the highest confidence to the candidate image together with their confidences and retain them.

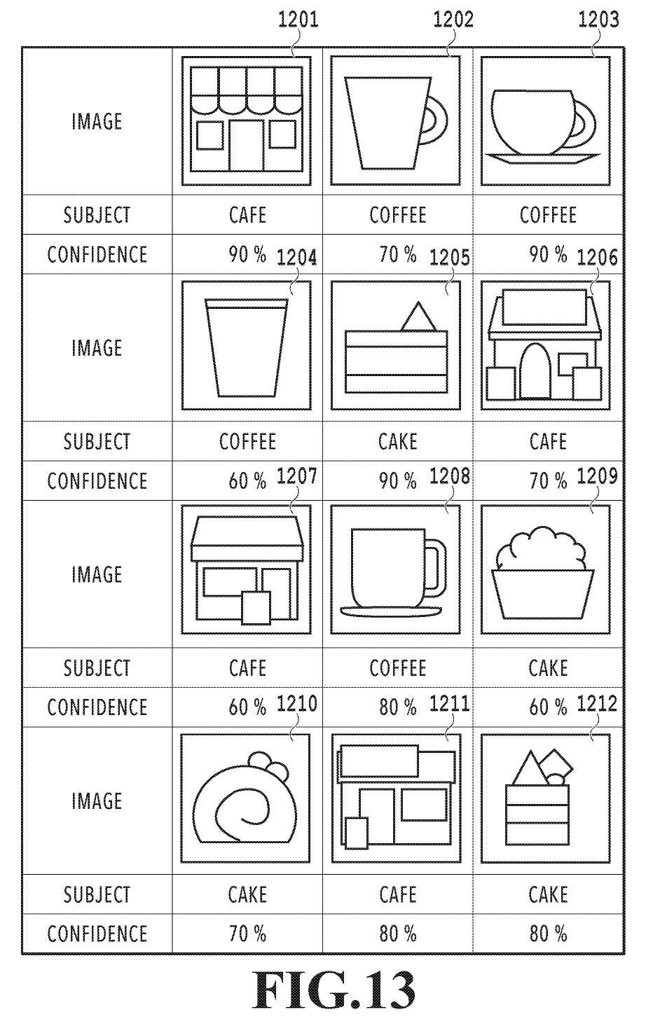

FIG. 13 is a diagram illustrating a list of the candidate images obtained in S1103, and subject information items and confidences linked to the candidate images. In FIG. 13, as images related to "cafe," 12 images are obtained, "cafe," "coffee," and "cake" are recognized as subjects, and text data items on the subjects are stored as subject information items. The automatic image adding unit 610 repeats the process of S1104 and S1105 for all the candidate images obtained in S1103. After the process has been completed on all the candidate images, the loop process is terminated, and the automatic image adding process proceeds to S1106. Hereinafter, the images obtained in S1103 will be referred to as candidate images.

In S1106, the candidate image displaying unit 607 of the automatic image adding unit 610 determines the order of arraying the candidate images on a basis of the subject information items on the candidate images and keywords extracted in S1101 and displays the order of arraying on the candidate image selection screen described later. The candidate image displaying unit 607 determines the order of arraying in accordance with the results of the image recognition in S1104. The order of arraying is determined through the execution of at least any one of the following processes (a) to (c).
(a) In a case where information indicating a subject recognized from a candidate image is included in an extracted keyword, that is, for a candidate image from which a subject matching an extracted keyword is recognized, the candidate image displaying unit 607 links the candidate image to the extracted keyword. The candidate image displaying unit 607 then determines the order of arraying such that the order of arraying corresponds to the priorities of the extracted keywords. That is, the candidate image displaying unit 607 determines the order of arraying such that an image linked to an extracted keyword having a high priority is displayed at a farther forward position, and an image linked to a keyword having a low priority is displayed at a farther backward position.
(b) In a case where information indicating a subject recognized from a candidate image is not included in an extracted keyword, that is, for a candidate image from which no subject matching an extracted keyword is recognized, the candidate image displaying unit 607 groups candidate images into groups such that candidate images having the same subject information item belong to the same group. Then, the candidate image displaying unit 607 determines the order of arraying the groups such that a group including a larger number of candidate images has a higher priority. The order of arraying candidate images in a group may be any order.
(c) The priority of a candidate image for which image recognition has failed is set to be lower than the priorities of the other candidate images.

For example, assume that, among candidate images obtained as images related to the keyword "cafe," a candidate image A has been recognized as an image of a restaurant, a candidate image B has been recognized as an image of a mug, and a candidate image C has been recognized as an image of a cake through the process of S1104. In this case, there is no candidate image matching "cafe" or "coffee" among the keywords extracted in S1101, and there is a candidate image matching "cake" among the keywords. The candidate image displaying unit 607 sets the priority of the candidate image C, which is recognized as an image of "cake" through the process (a), to be the highest in the order of arraying. The priorities of the candidate image A and the candidate image B are set to be lower than the priority of the candidate image C through the process (b). Note that the order of arraying the candidate images A and B is determined such that one of the candidate images A and B having a subject for which a larger number of images have the same subject information item has a higher priority. Accordingly, the order of arraying is determined as candidate images C, A, B or candidate images C, B, A.

In the example in FIG. 13, subject information items recognized from the candidate images match keywords extracted in S1101. Thus, the order of arraying is determined so as to correspond to the priorities of the extracted keywords through the process (a). As a result, the candidate images are displayed in groups based on subject information items in the order: "1. cafe, 2. coffee, 3. cake." Note that, in FIGS. 13 to 15, the same images as the images illustrated in FIG. 12 are given the same reference signs.

In S1107, the candidate image displaying unit 607 displays the candidate images on a candidate image selection screen 1400 in the order of arraying determined in S1106. Note that the order of arraying illustrated in the candidate image selection screen 1400 in FIG. 14 is the order of arraying the candidate images before a change by the changing unit 609.

FIG. 14 is a diagram illustrating an example of the candidate image selection screen 1400. The candidate image selection screen 1400 is displayed in S1107 of the automatic image adding process, which is started in response to a press of the "ADD AUTOMATICALLY" button 807 on the basic settings screen 1000. The candidate image selection screen 1400 includes a check box 1401, a candidate image display region 1402, scroll buttons 1403 and 1404, a cancel button 1405, and an OK button 1406. The check box 1401 is an operation object for switching between enabling and disabling a function of preferentially displaying candidate images including undesignated subjects. In a state where the check box 1401 is checked, the function of preferentially displaying the candidate images including the undesignated subjects is enabled (turned on), and in a state where the check box 1401 is unchecked, the function is disabled (turned off). In the candidate image display region 1402, the images obtained in S1103 (the candidate images) are displayed in the order of arraying determined in S1106. A press of an image displayed in the candidate image display region 1402 by the user with a mouse or the like brings the image into a selected state. An operation on the OK button 1406 with an image being selected designates the image in the selected state as a designated image to be used in the poster and then makes a transition to the basic settings screen 1000 in FIG. 10. The designated image is added to and displayed in the image designation region 805 of the basic settings screen 1000. An operation on the cancel button 1405 cancels an operation performed on the candidate image selection screen 1400 and makes a transition to the basic settings screen 1000, which is the previous screen.

In the example in FIG. 14, the candidate images 1201, 1211, 1206, and 1207, which have "cafe" as their subject information items, are displayed at a forward position in the candidate image display region 1402. Next, the candidate images 1203 and 1208, which have "coffee" as their subject information items, are displayed. In a case where the display is switched to the next page with the scroll button 1404, the candidate images 1202 and 1204, which have "coffee" as their subject information items, are subsequently displayed. At farther backward positions than the candidate images 1202 and 1204, the candidate images 1205, 1209, 1210 and 1212, which have "cake" as their subject information items, are displayed.

Note that it is assumed that priorities in the order of arraying in the example in FIG. 14 are determined such that, in a vertical direction, an image in an upper tier has a higher priority, and such that, in a lateral direction, an image on the left has a higher priority. Accordingly, the leftmost position in the uppermost row is the position of the highest priority. The priority next decreases from left to right in the same tier and next decreases from left to right in the following tier. In a case where the candidate image display region spans a plurality of pages, it is assumed that the first page has the highest priority, and the priority decreases in the order: the second page and the third page. Note that the priorities in the order of arraying in the candidate image display region 1402 are not limited to this example. For example, the order of arraying may be such that the priority decreases in the order: the leftmost position in an upper tier, the leftmost position in a lower tier, the second leftmost position in the upper tier, the second leftmost position in the lower tier, the rightmost position in the upper tier, and the rightmost position in the lower tier. Alternatively, the candidate images may be displayed in one tier such that the priority decreases in order from left to right, or the candidate images may be displayed in three tiers or more.

In a state where the candidate images are displayed on the candidate image selection screen 1400, the selection receiving unit 608 of the automatic image adding unit 610 receives a selection of an image or an operation on the check box by the user. The order of arraying the candidate images is determined in S1106 on a basis of their subjects. Thus, the candidate images are displayed on the candidate image selection screen 1400 in groups based on the subjects. This allows the user to compare images including a subject of the same type, for a selection.

In S1108, the automatic image adding unit 610 receives an operation on the check box 1401 of the candidate image selection screen 1400. As mentioned above, a state where the check box is checked is a state of being on, where the function of preferentially displaying the candidate images including the undesignated subjects is enabled.

In S1109, the automatic image adding unit 610 determines whether the check box is in the state of being on. In a case where the check box is in the state of being on, the automatic image adding process proceeds to S1110. In a case where the check box is in a state of being off, the automatic image adding process proceeds to S1111.

In S1110, the automatic image adding unit 610 determines whether a designated image has been designated. In a case where one or more images have already been added to the image designation region 805 of the basic settings screen 1000, the automatic image adding unit 610 determines that a designated image has been designated, and the automatic image adding process proceeds to S1116. In a case where no designated image has been added to the image designation region 805, the automatic image adding unit 610 determines that there is no designated image, and the automatic image adding process proceeds to S1111.

S1116 to S1118 constitute a loop process that targets all designated images that have been added to the image designation region 805 as the designated images. The loop process is executed in a case where one or more designated images have been added, and in a case where the function of prioritizing the undesignated subjects is enabled (the check box is turned on). Note that the loop process targets not only designated images added through an operation on the "ADD FROM FILE" button 806 or a drag-and-drop operation but also candidate images selected through the automatic image adding process as designated images.

In S1116, the automatic image adding unit 610 performs image recognition on each of the images added as the designated image and obtains a subject information item and information on a confidence as an image recognition result. It may suffice that the image recognition in S1116 is performed according to the same method as in S1104.

In S1117, the automatic image adding unit 610 links the information indicating a subject and a confidence of the subject that are obtained as the image recognition result, to the image, and stores them. As the subject information item, a subject information item having the highest confidence may be saved, or all subject information items successfully recognized may be saved together with information items on confidences.

In S1118, the changing unit 609 of the automatic image adding unit 610 sets the priority of a keyword that matches the subject information item recognized in S1116 to be lower than the lowest priority at that time. For example, assume that the user has selected a candidate image of "cafe" as the designated image from the candidate image display region 1402 in FIG. 11. In this case, the priority of the subject information item of "cafe" is set to be the lowest through the process in S1118. As a result, the order of the priorities of the candidate images are "coffee," "cake," and "cafe" in descending order. As a result of the loop process in S1116 to S1118, the priorities of the candidate images are changed. Thus, the priorities of candidate images having the same subject information item as a subject recognized from the designated image are set to be lower than the priorities of candidate images having subject information items different from this subject information item.

In S1119, the changing unit 609 sorts the candidate images displayed on the candidate image selection screen 1400 in the order of the priorities that have been changed through the process in S1116 to S1118 for display. Note that the candidate image added as the designated image is not displayed on the candidate image selection screen.

FIG. 15 is a diagram illustrating an example of a candidate image selection screen 1500 after the sort by the changing unit 609. In FIG. 15, a check mark is input into the check box 1401, and the function of prioritizing the undesignated subjects is enabled. Through the process in S1116 to S1118, the priorities of candidate images having the same subject information item as the subject "cafe" of the designated image are changed to be the lowest. This causes images of "coffee" and images of "cake" are displayed in this order at farther forward positions than (more preferentially than) images of "cafe" on the candidate image selection screen 1500 after the change. That is, the candidate images 1203, 1208, 1202, and 1204, the subjects of which are "coffee," are displayed at forward positions in the first page, and the candidate images 1205 and 1212, the subjects of which are "cake," are displayed at backward positions in the first page, and the second and subsequent pages. In the second and subsequent pages, undesignated images out of the candidate images the subjects of which are "cafe" (candidate images that have not been selected as designated images) are displayed at farther backward positions than the candidate images the subjects of which are "cake."

Note that, in the determination of the priorities in S1118, the changing unit 609 may display the undesignated candidate images on the candidate image selection screen 1500 after excluding candidate images having a subject information item that matches the designated image of the designated image. In a case where excluding images having a specific subject in this manner removes candidate images to be displayed, the process of the exclusion may be controlled so as not to be performed. Although it is assumed that the designated images targeted by the loop process in S1116 to S1118 include both images designated through an operation on the "ADD FROM FILE" button or the drag-and-drop operation and images selected through the automatic image adding process, the designated images may include either the images designated or the images selected. After the order of arraying the candidate images is changed in S1119, the automatic image adding process proceeds to S1120.

In S1120, in a case where the check box 1401 is changed from the state of being on to the state of being off by the user, the function of preferentially displaying the candidate images including the undesignated subjects is disabled, and the automatic image adding process proceeds to S1121. In a case where the check box 1401 is not changed to off, the automatic image adding process proceeds to S1111 with the order of arraying in S1119 being maintained.

In S1121, the changing unit 609 sorts the candidate images in the order of arraying determined in S1106. Then, the automatic image adding process proceeds to S1111.

In S1111, the selection receiving unit 608 receives a selection of a candidate image by the user. The selection of the candidate image by the user causes the automatic image adding process to proceed to S1112. In S1112, in a case where the user operates the OK button 1406, the automatic image adding process proceeds to S1113. In S1112, in a case where the OK button 1406 is not operated, the automatic image adding process proceeds to S1114. The automatic image adding process also proceeds to S1114 in a case where no image is selected in S1111.

In S1114, in a case where the cancel button 1405 is operated, the automatic image adding process proceeds to S1115. In a case where the cancel button 1405 is not operated, the automatic image adding process returns to S1111.

Note that an operation of a scroll button 1403 or 1404 may be received in a state where no image is selected. In a case where a scroll operation is performed, the candidate image displaying unit 607 makes a transition of the page displayed on the candidate image display region to the next page or the previous page.

In S1115, the automatic image adding unit 610 erases the candidate images displayed on the candidate image selection screen 1400, and the automatic image adding process proceeds to S901. In S901, the basic settings screen 1000 is displayed.

In S1113, the selection receiving unit 608 adds the selected candidate image as a designated image. The image designating unit 604 designates the added image as a designated image and counts the number of designated images. After S1113, the flowchart is terminated.

Note that, after the selection receiving unit 608 adds the selected candidate image as a designated image in S1113, the automatic image adding process may proceed to S1116. In this case, the priorities of candidate images including a subject of the same type as that of the subject included in the candidate image added in S1113 are changed to be lower, and the positions of the candidate images in the order of arraying are changed to backward positions. Before the changing unit 609 changes the order of arraying, the user may be allowed to select whether to array and display the candidate images in groups based on the subjects. In a case where the user selects displaying the candidate images not in groups based on the subject, it may suffice that the candidate images may be displayed in any order of arraying, without the execution of the process in S1104 to S1106. Note that, even in this case, the candidate images are sorted through the process in S1116 to S1119 in a case where the check mark is input into the check box 1401, and the function of prioritizing the undesignated subjects is set to be enabled.

As seen from the above, according to the first embodiment, candidate images including subjects different from the subject of an image that has already been selected as a designated image by a user are preferentially displayed, and the candidate images including the subject of the image selected as the designated image are displayed at backward positions. This enables the user to efficiently select a designated image from the candidate images including the undesignated subjects. Furthermore, before the sorting, the priorities are determined on a basis of the keywords extracted from the texts input by the user and the subjects of the candidate images, and the candidate images are displayed in descending order of priority in groups based on the subjects. Thus, the designated image can be efficiently selected. From the above, usability in selecting an image can be improved.

### Second Embodiment

In the first embodiment, the method in which the editing app obtains candidate images on a basis of texts input by a user and displays the candidate images on the candidate image display region in such a manner as to lower, in a case where an image has been added as the designated image, the priority of a subject of the same type as a subject of the designated image has been described. Meanwhile, there is also a case where the priorities of candidate images including a specific subject are to be lowered for displaying, or candidate images including a specific subject are to be preferentially displayed, irrespective of the presence or absence of a designated image. In a second embodiment, a method of changing the priority of a specific subject in displaying candidate images will be described. Note that, also in the second embodiment, an example of creating a layout data item on a poster of a cafe using the auto design function of the editing app will be employed, and an example of operations in a case where a user prepares no image to be put on the poster will be described.

A system configuration of a print system, hardware configurations and software configurations of apparatuses in the second embodiment are substantially the same as in the first embodiment (FIGS. 1 to 5). Thus, the description thereof will be omitted, and the same units will be given the same reference signs for description. In addition, the template data item, the basic settings screen, and the layout data generating process are substantially the same as in the first embodiment (FIGS. 7 to 9). Thus, the description thereof will be omitted. In the second embodiment, a general functional configuration of an editing app is substantially the same as illustrated in FIG. 6. However, a part of the processing by the candidate image displaying unit 607 and the changing unit 609 in the automatic image adding unit 610 differs from the first embodiment. The following will mainly describe differences from the first embodiment.

First, the second embodiment differs from the first embodiment in a screen configuration of the candidate image selection screen in which candidate images are displayed in the automatic image adding process.

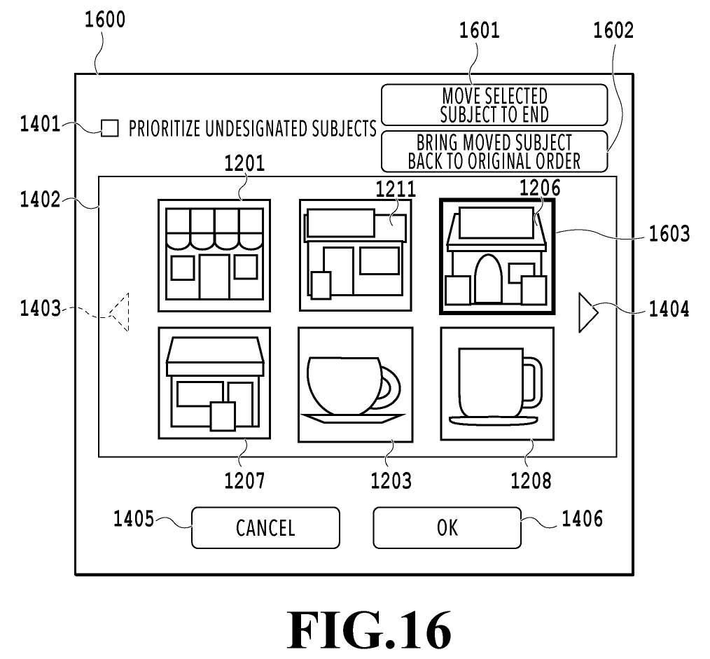

FIG. 16 is a diagram illustrating an example of a candidate image selection screen 1600 in the second embodiment. The candidate image selection screen 1600 differs from the candidate image selection screen 1400 in the first embodiment (FIG. 14) in that the candidate image selection screen 1600 is provided with a sort button 1601 and an initialization button 1602. The sort button 1601 (a first operating section) is an operation object for receiving an instruction to change the order of arraying candidate images from a user. Specifically, the sort button 1601 is an operation object for inputting an instruction to sort the candidate images displayed in the candidate image display region 1402 in such a manner as to lower the priorities of candidate images having the same subject information item as a subject information item on an image selected by the user. The initialization button 1602 (a second operating section) is an operation object for bringing the order of arraying the candidate images sorted in response to an operation on the sort button 1601 back to an original order of arraying. In FIG. 16, a selected candidate image is displayed with a selection frame 1603, which clearly indicates a selected state. In the candidate image selection screen 1600 illustrated in FIG. 16, the same sections as in the candidate image selection screen 1400 in the first embodiment (FIG. 14) are given the same reference signs.

### Automatic Image Adding Process in Second Embodiment

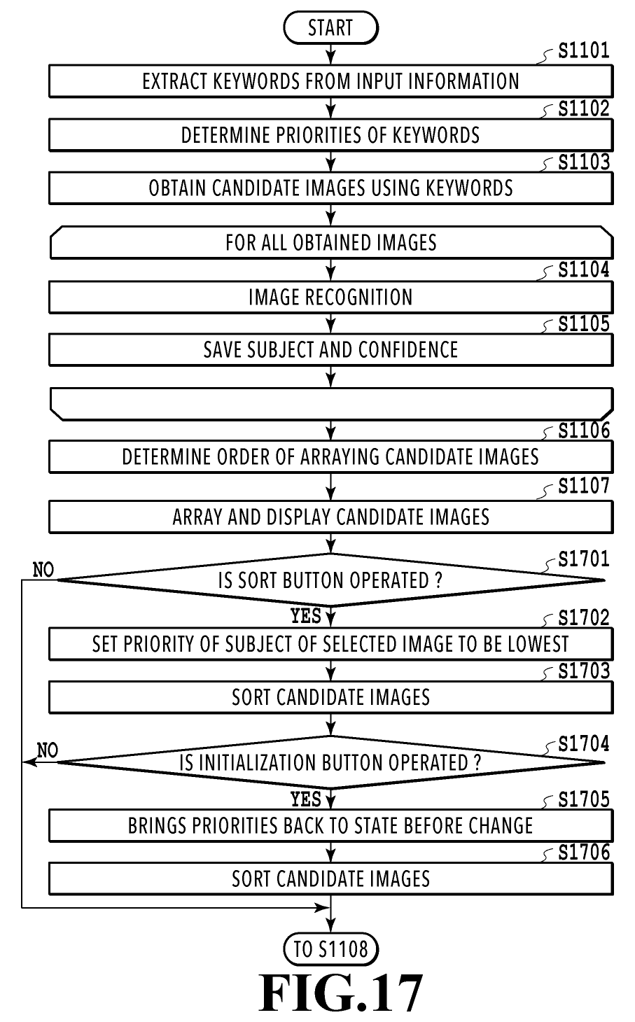

FIG. 17 is a flowchart for describing a flow of an automatic image adding process in the second embodiment. The process illustrated in the flowchart in FIG. 17 is included in at least any one of the server program and the client program of the editing app, as in the first embodiment. The program is invoked by the CPU of the server 101 or the CPU of the client terminal 102, loaded onto the RAM, and executed by the CPU. S1101 to S1107 of the flowchart in FIG. 17 are the same as S1101 to S1107 of the automatic image adding process in the first embodiment (FIG. 11). The following will mainly describe S1701 to S1705, which differ from the first embodiment. Note that, in the process of displaying candidate images in S1107, the candidate image displaying unit 607 is assumed to display the candidate image selection screen 1600 illustrated in FIG. 16. In addition, the ranks of priorities of the keywords determined through the process in S1101 to S1106 are assumed to be "1. cafe, 2. coffee, 3. cake," as in the first embodiment. This causes the candidate image selection screen 1600 illustrated in FIG. 16 to display candidate images such that the priorities of the candidate images 1201, 1211, 1206, and 1207, which have the subject information item "cafe," are higher than the priorities of the candidate images 1203 and 1208, which have the subject information item "coffee." In addition, the candidate image 1206 is in a state of being selected by the user.

After the candidate image selection screen 1600 illustrated in FIG. 16 is displayed, the automatic image adding process proceeds to S1701.

In S1701, in a case where the sort button 1601 is operated, the automatic image adding process proceeds to S1702. In a case where the sort button 1601 is not operated, the automatic image adding process proceeds to S1108 in FIG. 11. The process in S1108 and subsequent steps are substantially the same as in the first embodiment, and thus the description thereof will be omitted.

In S1702, the changing unit 609 of the automatic image adding unit 610 sets the priority of an extracted keyword that matches a subject information item recognized from the selected image to be lower than the lowest priority at that time. As illustrated in FIG. 16, the candidate image 1206, which has the subject information item "cafe," is selected, and thus the priorities of keywords are changed to the order: "1. coffee, 2. cake, 3. cafe."

In S1703, the changing unit 609 of the automatic image adding unit 610 sorts the candidate images on a basis of the priorities set in S1702.

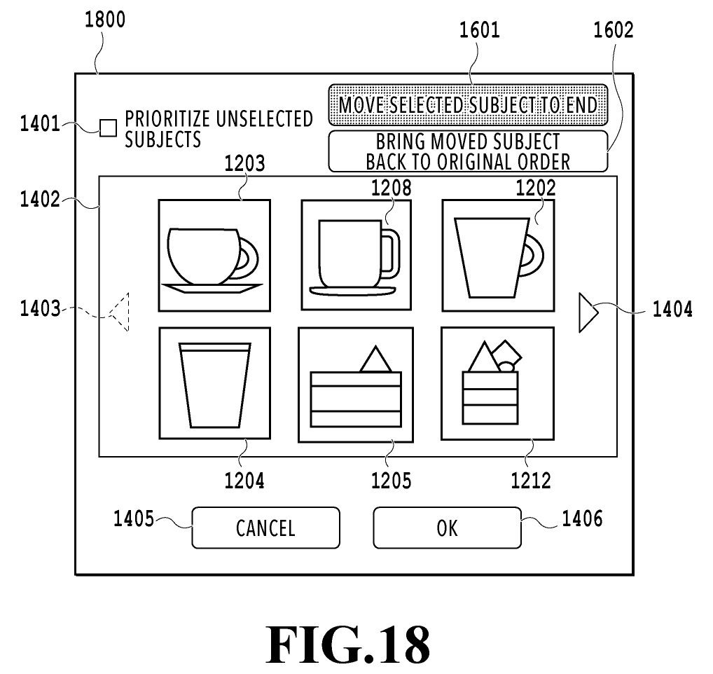

FIG. 18 is a diagram illustrating an example of a candidate image selection screen 1800 after the sort in response to an operation on the sort button 1601. In FIG. 18, the same section as in FIG. 16 is given the same reference signs as in FIG. 16. As mentioned above, the priorities of the extracted keywords are changed such that the priority of "cafe" is the lowest. Therefore, the candidate image selection screen 1800 displays the candidate images 1203, 1208, 1202, and 1204, which have the subject information item "coffee," and the candidate images 1205 and 1212, which have the subject information item "cake." The candidate images 1201, 1211, 1206, and 1207, which have the subject information item "cafe," are thus displayed at farther backward positions than the candidate images having the subject information item "cake," that is, in the second and subsequent pages.

In S1704, in a case where the initialization button 1602 is operated, the automatic image adding process proceeds to S1705. In a case where the initialization button 1602 is not operated, the automatic image adding process skips S1705 and S1706, proceeding to S1108 in FIG. 11.

In S1705, the changing unit 609 of the automatic image adding unit 610 brings the priorities changed in S1702 back to the state before the change (initializes the priorities). The initialization brings the priorities of the extracted keywords back to the priorities determined in S1102.

In S1706, the changing unit 609 of the automatic image adding unit 610 sorts the candidate images on a basis of the priorities initialized in S1705. As a result, the order of arraying the candidate image is brought back to the order of arraying in FIG. 16. After the process in S1706 is terminated, the automatic image adding process proceeds to S1108 in FIG. 11.

Note that in a case where the extracted keywords extracted in S1101 do not match the subject of a candidate image recognized in S1104, a subject information item (text data item) indicating the recognized subject is to be treated as the keyword of the candidate image. In this case, it may suffice that the initialized order of arraying is determined as in the method of determining the order of arraying shown in (a) to (c) in S1106.

As seen from the above, according to the second embodiment, the priorities of candidate images including a specific subject can be changed irrespective of the presence or absence of a designated image. Thus, even in a case where no designated image is designated, the order of arraying the candidate images can be changed in such a manner as to lower the priority of a specific subject selected by the user, enabling the user to efficiently select an image of a desired subject. From the above, usability in selecting an image can be improved.

Although, in the second embodiment, the priorities are changed in response to an operation on the sort button 1601 in such a manner as to lower the priority of a subject included in a candidate image in the selected state to the lowest, the change of the priorities is not limited to this. An operation on the sort button 1601 may change the priority of a subject included in a candidate image in the selected state to the highest. In addition, although the candidate image selection screen 1600 is configured to be provided with the sort button 1601 and the initialization button 1602 separately, the candidate image selection screen 1600 is not limited to this. Only the sort button 1601 is displayed, and the sort button 1601 may be configured to function as the initialization button in a state where the sort button 1601 has been pressed. Alternatively, an operation button for raising a priority and an operation button for lowering a priority may be provided, and the user may select any one of the buttons to change the priority of a subject included in a candidate image in the selected state for sorting.

### Third Embodiment

In the first and second embodiments, the order of arraying candidate images is changed such that candidate images including a subject of the same type as a subject recognized from a designated image or a specific image such as a candidate image selected by a user are displayed at farther backward positions than candidate images not including the subject. In a third embodiment, an example in which a user is allowed to select a subject the priority of which is to be changed will be described. That is, the automatic image adding unit 610 of the editing app displays the list of extracted keywords or subject information items recognized from the candidate images, receives an operation for changing ranks in the list, and sorts the candidate images in accordance with the ranks set in the list. Note that, also in the third embodiment, an example of creating a layout data item on a poster of a cafe using the auto design function of an editing app will be employed, and an example of operations in a case where a user prepares no image to be put on the poster will be described.

A system configuration of a print system, hardware configurations and software configurations of apparatuses in the third embodiment are substantially the same as in the first embodiment (FIGS. 1 to 5). Thus, the description thereof will be omitted, and the same units will be given the same reference signs for description. In addition, the template data item, the basic settings screen, and the layout data generating process are substantially the same as in the first embodiment (FIGS. 7 to 9). Thus, the description thereof will be omitted. In the third embodiment, a part of the processing by the automatic image adding unit 610 of the editing app differs from the first embodiment. The following will mainly describe differences from the first embodiment.

First, the third embodiment differs from the first embodiment in a screen configuration of the candidate image selection screen in which candidate images are displayed in the automatic image adding process.

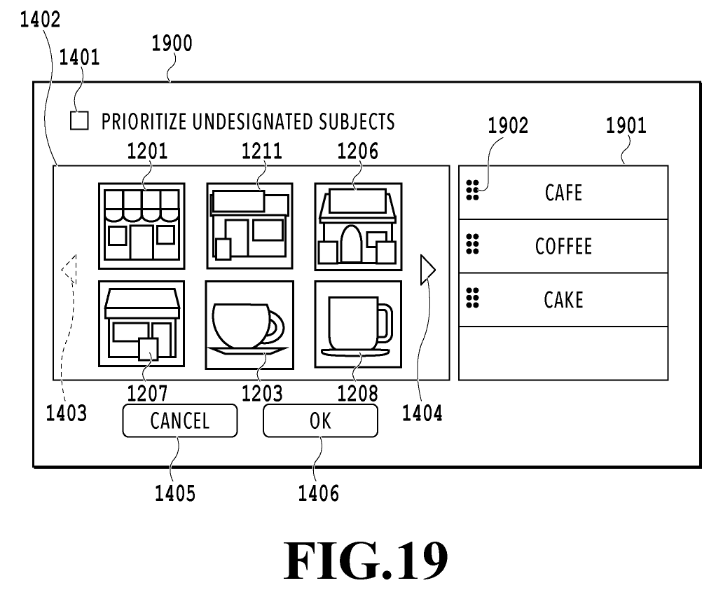

FIG. 19 is a diagram illustrating an example of a candidate image selection screen 1900 in the third embodiment. The candidate image selection screen 1900 differs from the candidate image selection screen 1400 in the first embodiment (FIG. 14) in that a keyword list 1901 is displayed together with the candidate image display region 1402. The keyword list 1901 displays a list of keywords linked to candidate images in the order of the priorities set to the candidate images. In a case where the keywords linked to the candidate images are linked to the extracted keywords extracted in S1101, that is, in a case where subject information items recognized from the candidate images match the extracted keywords, the keywords are the extracted keywords. In a case where the candidate images are not linked to the extracted keywords extracted in S1101, that is, in a case where the subject information items recognized from the candidate images do not match the extracted keywords, the keywords are text data items indicating subjects recognized from the candidate images (subject information items). In the example in FIG. 19, the keywords "cafe," "coffee," and "cake" are displayed from up to down in this order in the keyword list 1901. Handles 1902 in the keyword list 1901 are operation objects for changing the order of displaying the keywords in the keyword list 1901. By performing a drag operation on one of the handles 1902 provided in display boxes of the keywords, the display position of the corresponding keyword can be changed to the position of any rank. Note that the order of displaying in the keyword list indicates the priorities (ranks) of the keywords. With a change in the order of displaying in the keyword list, the priorities of the keywords are changed. Thus, the order of arraying the candidate images in the candidate image display region 1402 is changed to the order of arraying the keywords linked to the candidate images. In the candidate image selection screen 1900 illustrated in FIG. 19, the same sections as in the candidate image selection screen 1400 in the first embodiment (FIG. 14) are given the same reference signs.

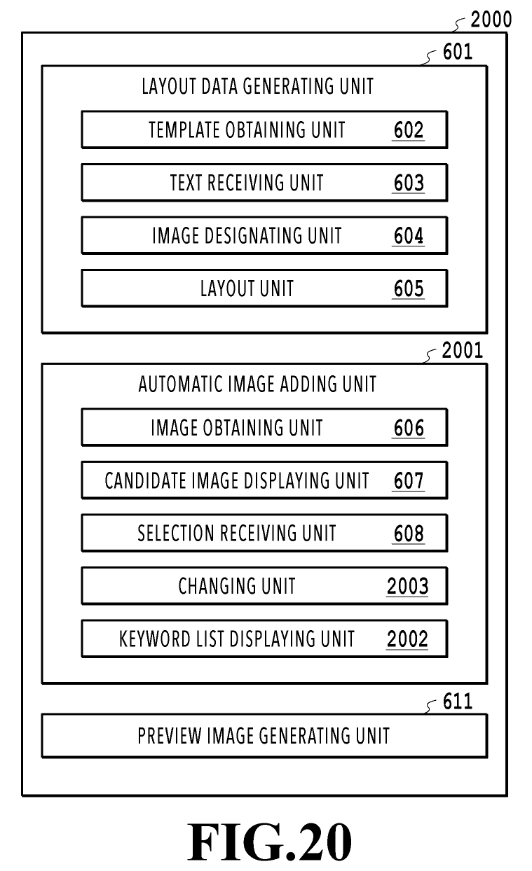

FIG. 20 is a diagram illustrating a functional configuration of an editing app 2000 in the third embodiment. The functional configuration differs from the functional configuration of the editing app in the first embodiment in that the editing app 2000 includes a keyword list displaying unit 2002 in an automatic image adding unit 2001. In addition, a changing unit 2003 differs from the changing unit 609 in the first embodiment in that the changing unit 2003 changes the priorities of the keywords with a change of the order of displaying in the keyword list 1901.

The keyword list displaying unit 2002 displays the list of the keywords linked to the candidate images. As mentioned above, the keywords linked to the candidate images are subject information items recognized from the candidate images. In a case where a subject information item recognized from a candidate image matches one of the extracted keywords extracted in S1101, the extracted keyword is a keyword linked to the candidate image. In a case where a subject information item recognized from a candidate image matches none of the extracted keywords extracted in S1101, a text data item indicating the subject information item recognized from the candidate image is a keyword linked to the candidate image.

The keyword list displaying unit 2002 displays the keywords linked to the candidate images in the order of the priorities of the keywords. The priorities of the keywords are determined through the process in S1102. In addition, in the third embodiment, the order of the priorities of the keywords matches the order of displaying in the keyword list 1901. In the example in FIG. 19, it is assumed that an upper position indicates a higher priority rank, and a lower position indicates a lower priority rank. The order of displaying can be changed in response to an operation by the user.

The keyword list displaying unit 2002 receives a change of the order of arraying the keywords (subject information items) in the keyword list 1901, from the user. In a case where the user performs a drag-and-drop operation on one of the handles 1902 provided in the display boxes of the keywords, the keyword list displaying unit 2002 transposes the display positions of the keywords. With a change of the order of displaying in the keyword list 1901, the keyword list displaying unit 2002 changes the priorities of the keywords.

The changing unit 2003 changes the order of arraying of the candidate images in the candidate image display region 1402 such that the order of arraying corresponds to the order of the priorities of the keywords that has been changed with the change of the order of displaying in the keyword list 1901. Thus, the order of displaying of the candidate images can be changed in units of the keywords linked to the candidate images, that is, in the units of subjects.

### Automatic Image Adding Process in Third Embodiment

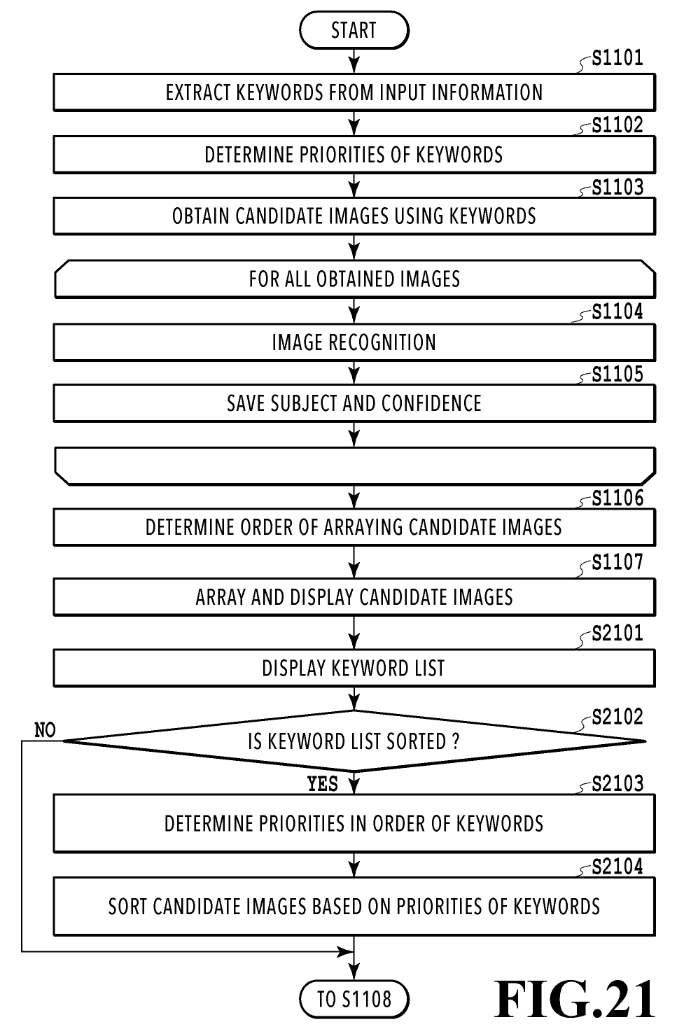

FIG. 21 is a flowchart for describing a flow of an automatic image adding process in the third embodiment. The process illustrated in the flowchart in FIG. 21 is included in at least any one of the server program and the client program of the editing app, as in the first embodiment. The program is invoked by the CPU of the server 101 or the CPU of the client terminal 102, loaded onto the RAM, and executed by the CPU. S1101 to S1107 of the flowchart in FIG. 21 are the same as S1101 to S1107 of the automatic image adding process in the first embodiment (FIG. 11). The following will mainly describe S2101 to S2104, which differ from the first embodiment. Note that, in the process of displaying candidate images in S1107, the candidate image displaying unit 607 is assumed to display the candidate images on the candidate image selection screen 1900 illustrated in FIG. 19. In addition, the ranks of priorities of the keywords determined through the process in S1101 to S1106 are assumed to be "1. cafe, 2. coffee, 3. cake," as in the first embodiment. This causes the candidate image selection screen 1900 illustrated in FIG. 19 to display candidate images such that the priorities of the candidate images 1201, 1211, 1206, and 1207, which have the subject information item "cafe," are higher than the priorities of the candidate images 1203 and 1208, which have the subject information item "coffee."

After the candidate images are displayed on the candidate image selection screen 1900 through the process in S1101 to S1107 in the order of arraying determined in S1106, the automatic image adding process proceeds to S2101.

In S2101, the keyword list displaying unit 2002 displays the keyword list 1901. As illustrated in FIG. 19, the keyword list 1901 displays the extracted keywords "cafe," "coffee," and "cake," which have been extracted in S1101 in the order of the priorities determined in S1102. Note that in a case where the subject recognized in S1104 matches none of the keywords extracted in S1101, a subject information item (text data item) indicating the recognized subject is to be treated as the keyword of the candidate image. In this case, it may suffice that the priorities of the keywords are determined as in the method of determining the order of arraying shown in (a) to (c) in S1106.

After the candidate images and the keyword list 1901 are displayed, the automatic image adding unit 610 executes the process in S2102.

In S2102, in a case where a sort operation is performed on the keyword list 1901, the automatic image adding process proceeds to S2103. In a case where the sort operation is not performed on the keyword list 1901, the automatic image adding process proceeds to S1108 in FIG. 11. The process in S1108 and subsequent steps is substantially the same as in the first embodiment, and thus the description thereof will be omitted.

In S2103, the changing unit 2003 of the automatic image adding unit 2001 determines the priorities of the keywords, that is, the priorities of the candidate images according to the order of displaying in the keyword list 1901 that has been sorted.

In S2104, the changing unit 2003 of the automatic image adding unit 2001 sorts the candidate images such that the candidate images correspond to the priorities determined in S2103. After the process in S2104 is terminated, the automatic image adding process proceeds to S1108 in FIG. 11.

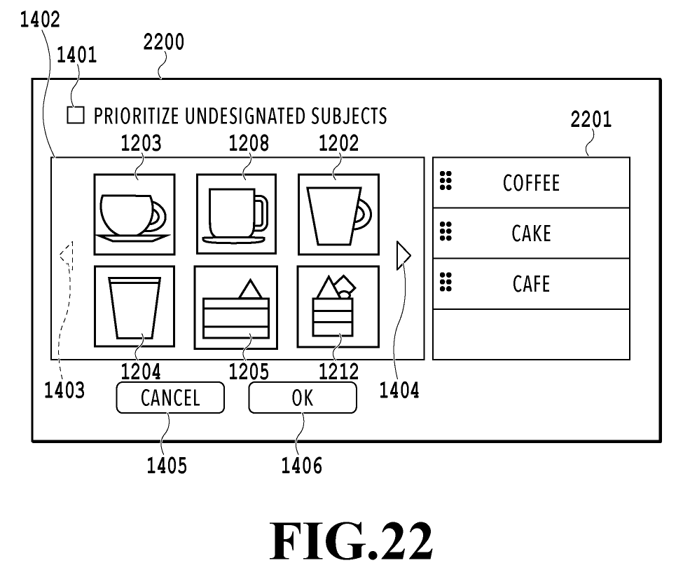

FIG. 22 is a diagram illustrating an example of a candidate image selection screen 2200 that is sorted by a sort operation on the keyword list 1901. As illustrated in the keyword list 1901 illustrated in FIG. 19, in a case where the order of arraying the keywords is "cafe," "coffee," and "cake" from up to down, the priorities are "1. cafe, 2. coffee, 3. cake." In a case where the order of arraying the keywords in the keyword list 1901 is changed from this state to "coffee," "cake," and "cafe" from up to down as illustrated in FIG. 22, the priorities are changed to "1. coffee, 2. cake, 3. cafe." The candidate image displaying unit 607 changes the order of arraying the candidate images according to the changed priorities. As illustrated in FIG. 22, the candidate images are displayed in the order: "coffee," "cake," and "cafe."

As seen from the above, according to the third embodiment, the list of subject information items (keywords) of candidate images is displayed, and a user can sort the candidate images displayed in the candidate image display region by changing the order of displaying the keywords in the keyword list. Thus, the user can change the priorities of the candidate images with an operation on the keyword list, and the user can efficiently select an image of a desired subject even in a case where the number of candidate images is large. From the above, usability in selecting an image can be improved.

Although, in the embodiments mentioned above, the editing apps having the auto design function for a poster and the like have been described as examples of the application, the application is not limited to these examples. The processing by the candidate image displaying unit and the changing unit is also applicable to various applications having the function of arraying and displaying a plurality of images.

In the embodiments mentioned above, the information processing apparatus used as the client terminal is assumed to be a personal computer. However, the information processing apparatus is not limited to this example. For example, a mobile phone, a personal digital assistant, a digital still camera, a digital video camera, a portable music player, a game console, a set-top box, a smart home appliance, or the like may be used. The present embodiments are applicable to any information processing apparatus (terminal) capable of arraying and displaying a plurality of images.

In the embodiments mentioned above, Ethernet is employed in the example of the network configuration. However, the network configuration is not limited to this. For example, any other network configuration such as wireless LAN, IEEE 1394, or Bluetooth may be employed.

The preferred embodiments of the present disclosure have been described above with reference to the accompanying drawings, whilst the present disclosure is not limited to the above examples. It is apparent that a person skilled in the art may conceive various alterations or modifications within the disclosed technical concepts, and it should be appreciated that they will naturally come under the technical scope of the present disclosure.

The present disclosure may be implemented as the process of providing a program that implements one or more of the functions of the embodiments mentioned above to a system or an apparatus over a network or via a storage medium and causing one or more processors in a computer of the system or the apparatus to read and execute the program. Alternatively, the present disclosure can be implemented in a form of a circuit that implements one or more of the functions (e.g., ASIC).

According to the present disclosure, it is possible to improve usability in preparing images for producing content.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-053970, filed Mar. 27, 2025, which is hereby incorporated by reference herein in its entirety.

What is claimed is:

1. An information processing apparatus comprising:
one or more processors; and
one or more memories storing instructions to cause the one or more processors to function as:
a display control unit configured to array and display a plurality of candidate images that are candidates for an image to be arranged in layout data on content; and
a changing unit configured to change an order of arraying the candidate images such that a first candidate image is displayed at a farther backward position than a second candidate image, the first candidate image being one of the candidate images that includes a first subject, the second candidate image being one of the candidate images that does not include the first subject, the first subject being a subject of a same type as a subject recognized from a specific image.

2. The information processing apparatus according to claim 1, wherein the specific image is a designated image that is designated by a user as an image to be arranged in the layout data.

3. The information processing apparatus according to claim 2, further comprising
a receiving unit configured to receive designation of the designated image, wherein
the changing unit changes the order of arraying the candidate images in a case where the receiving unit receives the designation of the designated image.

4. The information processing apparatus according to claim 3, wherein the designated image includes at least any one of an image selected from among the candidate images by the user and an image that is not included in the candidate images and designated by the user.

5. The information processing apparatus according to claim 1, wherein
the specific image is an image that is selected from among the candidate images by a user,
a screen on which the candidate images are displayed includes a first operating section configured to receive, from the user, an instruction to change the order of arraying in the changing unit, and
the changing unit changes the order of arraying the candidate images in a case where an operation on the first operating section is received in a state where the image is selected.

6. The information processing apparatus according to claim 5, wherein
the screen on which the candidate images are displayed further includes a second operating section configured to receive, from the user, an instruction to bring the order of arraying the candidate images back to a previous state, and
the changing unit brings, in a case where an operation on the second operating section is received, the order of arraying the candidate images back to an order of arraying before the operation on the first operating section is received.

7. The information processing apparatus according to claim 1, further comprising:
a character string receiving unit configured to receive, from the user, an input of a character string to be arranged in the layout data; and
a determining unit configured to determine the order of arraying the candidate images on a basis of priorities of a plurality of keywords extracted from the character string and the subject recognized from each of the candidate images, wherein
before a change by the changing unit, the display control unit displays the candidate images in the order of arraying determined by the determining unit.

8. The information processing apparatus according to claim 7, wherein the priorities are determined on a basis of frequencies of the keywords in the character string received by the character string receiving unit.

9. The information processing apparatus according to claim 7, wherein the determining unit makes the order of arraying the candidate images correspond to the priorities of the keywords in a case where information indicating the subject recognized from each of the candidate images is included in the keywords.

10. The information processing apparatus according to claim 9, wherein the determining unit further determines, for the keywords that are the same in the priorities, the order of arraying the candidate images on a basis of confidence that is an index indicating accuracy of a result of recognition of the subject.

11. The information processing apparatus according to claim 7, wherein the determining unit determines, in a case where information indicating the subject recognized from each of the candidate images is not included in the keywords, the order of arraying the candidate images on a basis of a number of the candidate images including the subject of a same type.

12. The information processing apparatus according to claim 1, further comprising
a setting unit configured to set whether changing of the order of arraying by the changing unit is to be enabled or disabled, wherein
the changing unit changes, in a case where the setting unit sets the changing to be enabled, the order of arraying the candidate images.

13. The information processing apparatus according to claim 1, wherein the display control unit displays the candidate images in groups based on the subject recognized from each of the candidate images.

14. The information processing apparatus according to claim 7, further comprising:
an obtaining unit configured to obtain template data and the candidate images on a basis of information received from the user; and
a layout unit configured to lay out, in the template data, the image selected by the user from among the candidate images obtained by the obtaining unit.

15. The information processing apparatus according to claim 14, wherein the obtaining unit obtains the candidate images through a search using the character string received from the user.

16. The information processing apparatus according to claim 14, wherein the obtaining unit obtains, as the candidate images, generated images that are generated by an image generation model using a prompt generated on a basis of information received from the user.

17. A display control method to be executed by an information processing apparatus, the display control method comprising:
arraying and displaying a plurality of candidate images that are candidates for an image to be arranged in layout data on content; and
changing an order of arraying the candidate images such that a first candidate image is displayed at a farther backward position than a second candidate image, the first candidate image being one of the candidate images that includes a first subject, the second candidate image being one of the candidate images that does not include the first subject, the first subject being a subject of a same type as a subject recognized from a specific image.

18. A non-transitory computer readable storage medium storing a program which causes a computer to function as:
a display control unit configured to array and display a plurality of candidate images that are candidates for an image to be arranged in layout data on content; and
a changing unit configured to change an order of arraying the candidate images such that a first candidate image is displayed at a farther backward position than a second candidate image, the first candidate image being one of the candidate images that includes a first subject, the second candidate image being one of the candidate images that does not include the first subject, the first subject being a subject of a same type as a subject recognized from a specific image.
